(19) United States
(12) Patent Application Publication
(10) Pub. No.: US 2023/0319930 A1
(43) Pub. Date: Oct. 5, 2023

(54) Adaptive Selection of a Network Access Mode by a User Equipment

(71) Applicant: Google LLC, Mountain View, CA (US)

(72) Inventors: Thomas Klingenbrunn, San Diego, CA (US); Hung Tsang, San Jose, CA (US); Aamir Akram, San Jose, CA (US)

(73) Assignee: Google LLC, Mountain View, CA (US)

(21) Appl. No.: 18/040,613

(22) PCT Filed: Jul. 20, 2021
(86) PCT No.: PCT/US2021/042417

§ 371 Date: Feb. 3, 2023

Related U.S. Application Data
(60) Provisional application No. 63/066,114, filed on Aug. 14, 2020.
(60) Provisional application No. 63/063,937, filed on Aug. 10, 2020.

(51) Int. Cl. H04W 76/16; H04W 60/04

(52) U.S. Cl. CPC H04W 76/16; H04W 60/04

(57) ABSTRACT

Techniques and apparatuses are described for adaptive selection of a network access mode by a user equipment. In aspects, a user equipment (UE) indicates, to a RAN, support for at least a first network access mode and a second network access mode and receives directions to operate in the first network access mode. While communicating in the RAN using the first network access mode, the UE detects a trigger event and determines to use the second network access mode based on at least one operational performance metric. In aspects, the UE indicates (740), to the RAN, that the UE supports the second network access mode without indicating that the UE supports the first network access mode, and transitions from the first network access mode to the second network access mode. The UE then communicates in the RAN using the second network access mode.

Various evolving wireless communication systems, such as fifth generation (5G) technologies and sixth generation (6G) technologies, support multiple network access modes. As one example, consider a Radio Access Network (RAN) that includes (a) support for a standalone (SA) network access mode in which a user equipment (UE) uses a single radio access technology (RAT) to communicate in the RAN, and (b) support for a non-standalone (NSA) network access mode in which the UE uses multiple RATs to communicate in the RAN. For instance, when operating in a 5G SA network access mode, a UE communicates using a single RAT (e.g., 5G). When operating in a 5G NSA network access mode, the UE communicates in the RAN using both 5G RAT communications and fourth generation (4G) RAT communications.

A network operator of a RAN oftentimes assigns a network access mode to a UE. To illustrate, the network operator may assign the SA network access mode to a UE that supports both SA and NSA to reduce the use of 4G air interface resources, to migrate more devices to 5G SA, or to provide the UE with lower data-transfer latency. However, the network access mode selected by the network operator may not always provide the UE with an optimal or desired operational performance.

### SUMMARY

This document describes techniques and apparatuses for adaptive selection of a network access mode by a user equipment. In aspects, a user equipment (UE) indicates, to a RAN, support for at least a first network access mode and a second network access mode and receives directions to operate in the first network access mode. While communicating in the RAN using the first network access mode, the UE detects a trigger event and determines to use the second network access mode based on at least one operational performance metric. In aspects, the UE indicates, to the RAN, that the UE supports the second network access mode without indicating that the UE supports the first network access mode, and transitions from the first network access mode to the second network access mode. The UE then communicates in the RAN using the second network access mode.

The details of one or more implementations of adaptive selection of a network access mode by a user equipment are set forth in the accompanying drawings and the following description. Other features and advantages will be apparent from the description, drawings, and claims. This summary is provided to introduce subject matter that is further described in the Detailed Description and Drawings. Accordingly, this summary should not be considered to describe essential features nor used to limit the scope of the claimed subject matter.

### BRIEF DESCRIPTION OF THE DRAWINGS

The details of one or more aspects of adaptive selection of a network access mode by a user equipment are described below. The use of the same reference numbers in different instances in the description and the figures indicate similar elements:

FIG. 1 illustrates an example operating environment in which various aspects of adaptive selection of a network access mode by a user equipment can be implemented.

FIG. 2 illustrates an example device diagram of network entities that can implement various aspects of adaptive selection of a network access mode by a user equipment.

FIG. 3 illustrates an example stack model that can implement various aspects of adaptive selection of a network access mode by a user equipment.

FIG. 4 illustrates a line graph that shows an example coverage deployment timeline in accordance with various aspects of adaptive selection of a network access mode by a user equipment.

FIGS. 5A-5C illustrate an example operating environment and corresponding analyses in which adaptive selection of a network access mode by a user equipment can be implemented in accordance with various aspects.

FIG. 6 illustrates an example operating environment in which adaptive selection of a network access mode by a user equipment can be implemented in accordance with various aspects.

FIG. 7 illustrates an example transaction diagram between various network entities that implement adaptive selection of a network access mode by a user equipment.

FIG. 8 illustrates an example transaction diagram internal to a user equipment that implements aspects of adaptive selection of a network access mode by a user equipment.

FIG. 9 illustrates an example transaction diagram between various network entities that implement adaptive selection of a network access mode by a user equipment.

FIG. 10 illustrates an example transaction diagram internal to a user equipment that implements aspects of adaptive network access mode selection.

FIG. 11 illustrates an example transaction diagram between various network entities that implement adaptive selection of a network access mode by a user equipment.

FIG. 12 illustrates an example method for adaptive selection of a network access mode by a user equipment.

### DETAILED DESCRIPTION

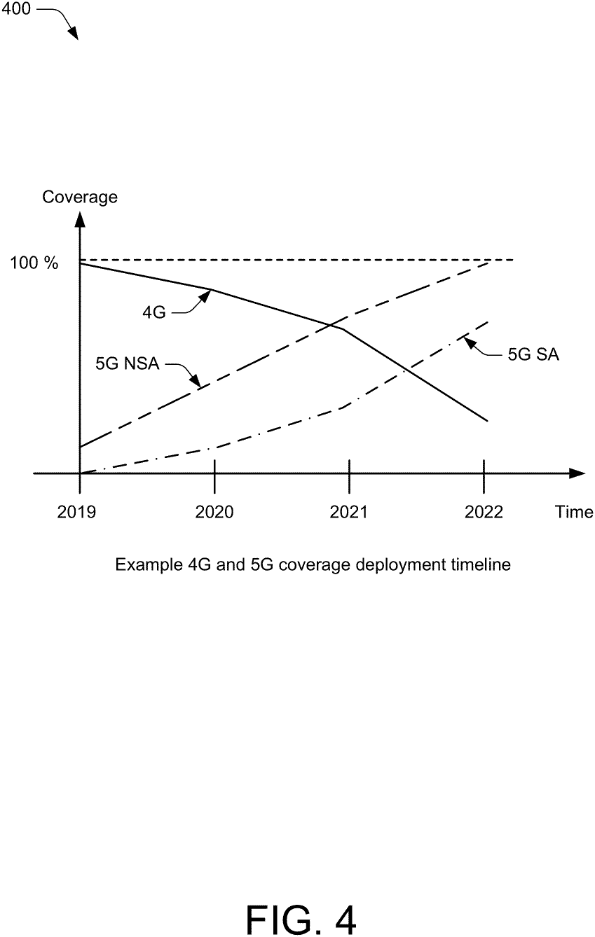

Evolving wireless technologies include multiple network access modes. To illustrate, fifth generation (5G) technologies include (a) a standalone (SA) access mode where a user equipment (UE) communicates in a Radio Access Network (RAN) using a single (cellular) wireless technology, and (b) a non-standalone (NSA) network access modes where the UE wirelessly communicates in the RAN using multiple (cellular) wireless technologies. Network operators oftentimes deploy different configurations for the evolving wireless technologies by using incremental deployment configurations, where each configuration augments the features provided by a prior configuration as described with reference to FIG. 4. To illustrate, a first deployment configuration of 5G SA may provide a UE with less data throughput relative to a second, future deployment configuration. Different network providers may also use different deployment configurations. As an example, a first network provider operating in a first region may deploy a different configuration for the wireless technology relative to a second network provider operating in a second, overlapping region. Thus, the different deployment configurations for each network access mode can affect the operational performance (e.g., data throughput, data-transfer latency) of a UE.

A configuration of a user equipment (UE) also affects the efficacy of a network access mode. For example, a UE that supports multiple network access modes may support fewer capabilities for a first network access mode relative to a second network access mode. To illustrate, 5G SA communicates using higher frequencies relative to the lower frequencies used by the fourth generation (4G) technologies included in 5G NSA. Although the higher frequency bands used by 5G SA provide the potential of higher data throughput (e.g., an amount of data successfully transferred), the hardware capabilities of the UE may result in performance limitations. As one example, the hardware configuration of a UE that supports both 5G SA and 5G NSA network access modes may only support one carrier corresponding to two Multiple-Input Multiple-Output (MIMO) layers as defined in 5G SA and alternatively supports three carriers corresponding to three MIMO layers as defined in 5G NSA and/or a 4G only mode. As another example, a UE’s location may limit what services are available from the RAN, because the position of a UE relative to a serving 5G base station combined with its processing power for 5G communications may limit the UE’s throughput. Thus, various factors (e.g., UE hardware configuration, network deployment configuration, UE location) can impact which network access mode provided by the RAN (e.g., a cellular network access mode) provides better performance to a UE relative to other (cellular) network access modes.

Oftentimes, a network controller (and/or base station) assigns a network access mode to a UE. For example, the network controller may direct the UE to operate in a first network access mode (e.g., 5G SA) provided by the RAN instead of a second network access mode (e.g., 5G NSA) provided by the RAN to provide the UE with lower data-transfer latency (e.g., a time between a departure of data from a source to the arrival of the data at a destination) and/or to reserve the air interface resources used by the second network access mode (e.g., 4G air interface resources) for other devices that lack support for the first network access mode. As another example, the network controller may direct the UE to operate in the second network access mode by default instead of the first network access mode based on priority. Thus, the network controller of the RAN may assign a network access mode to the UE without considering the performance capabilities or conditions of the UE.

In aspects of adaptive selection of a network access mode by a user equipment, a UE that supports multiple network access modes selects a network access mode and initiates a change to the network access mode. To illustrate, the UE analyzes various factors (e.g., network deployment configurations, UE hardware configuration, UE priorities, UE location) and selects the network access mode that results in better performance relative to other available network access modes. This allows the UE to override or manage selection of the network access mode to improve system performance at the UE.

### Example Environments

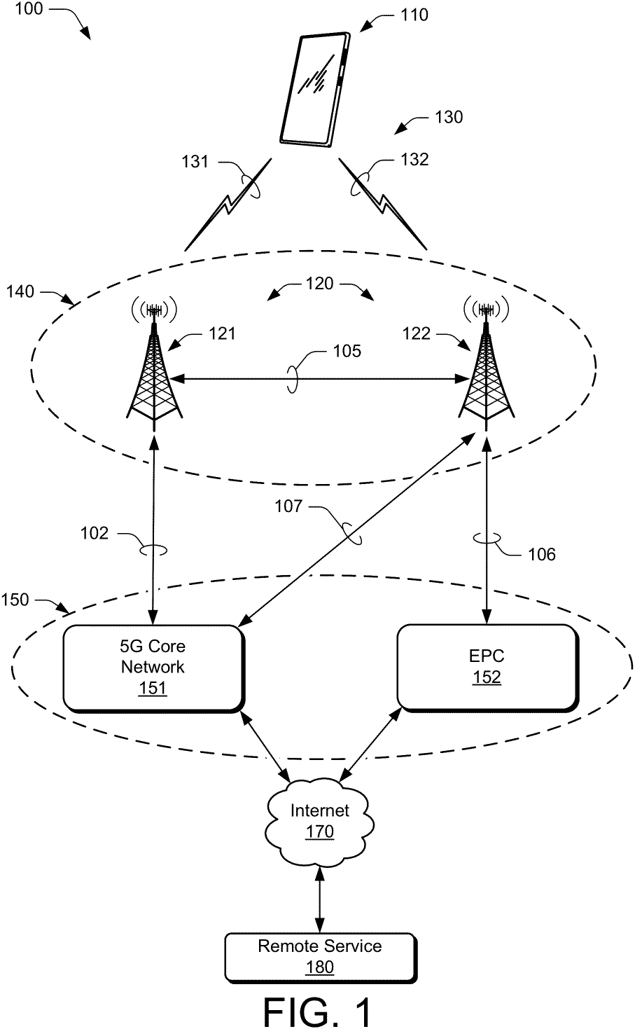

FIG. 1 illustrates an example environment 100, which includes a user equipment 110 (UE 110) that can communicate with base stations 120 (illustrated as base stations 121 and 122) through one or more wireless communication links 130 (wireless link 130), illustrated as wireless links 131 and 132. For simplicity, the UE 110 is implemented as a smartphone but may be implemented as any suitable computing or electronic device, such as a mobile communication device, modem, cellular phone, gaming device, navigation device, media device, laptop computer, desktop computer, tablet computer, smart appliance, vehicle-based communication system, or an Internet-of-Things (IoT) device such as a sensor or an actuator. The base stations 120 (e.g., an Evolved Universal Terrestrial Radio Access Network Node B, E-UTRAN Node B, evolved Node B, eNodeB, eNB, Next Generation Node B, gNode B, gNB, ng-eNB, or the like) may be implemented in a macrocell, microcell, small cell, picocell, distributed base station, and the like, or any combination thereof.

The base stations 120 communicate with the UE 110 using the wireless links 131 and 132, which may be implemented as any suitable type of wireless link. The wireless links 131 and 132 include control-plane information and/or user-plane data, such as downlink of user-plane data and control-plane information communicated from the base stations 120 to the UE 110, uplink of other user-plane data and control-plane information communicated from the UE 110 to the base stations 120, or both. The wireless links 130 may include one or more wireless links (e.g., radio links) or bearers implemented using any suitable communication protocol or standard, or combination of communication protocols or standards, such as 3rd Generation Partnership Project Long-Term Evolution (3GPP LTE), Fifth Generation New Radio (5G NR), and so forth. Multiple wireless links 130 may be aggregated in a carrier aggregation or multi-connectivity technology to provide a higher data rate for the UE 110. Multiple wireless links 130 from multiple base stations 120 may be configured for Coordinated Multipoint (CoMP) communication with the UE 110.

The base stations 120 are collectively a Radio Access Network 140 (e.g., RAN, Evolved Universal Terrestrial Radio Access Network, E-UTRAN, 5G NR RAN, NR RAN), where the RAN 140 communicates with one or more core networks 150 (core network 150). In aspects, the RAN provides and/or supports multiple network access modes that allow a device (e.g., the UE 110) to communicate using the RAN. To illustrate, the base station 121 connects, at interface 102, to a 5G core network 151 (5GC 151) through an NG2 interface for control-plane signaling and using an NG3 interface for user-plane data communications. The base station 122 connects, at interface 106, to an Evolved Packet Core 152 (EPC 152) using an S1 interface for control-plane signaling and user-plane data communications. Optionally or additionally, if the base station 122 connects to the 5GC 151 and EPC 152 networks, the base station 122 connects to the 5GC 151 using an NG2 interface for control-plane signaling and through an NG3 interface for user-plane data communications, at interface 107. Accordingly, the base stations 120 can communicate with multiple core networks 150 (e.g., 5GC 151, EPC 152).

In addition to wireless links to core networks, the base stations 120 may communicate with each other. For example, the base stations 121 and 122 communicate through an Xn interface at interface 105 to coordinate proportioning air interface resources as further described.

The UE 110 may connect, via the 5G core network 151 or the Evolved Packet Core Network 152, to public networks, such as the Internet 170 to interact with a remote service 180. The remote service 180 represents the computing, communication, and storage devices used to provide any of a multitude of services including interactive voice or video communication, file transfer, streaming voice or video, and other technical services implemented in any manner such as voice calls, video calls, website access, messaging services (e.g., text messaging or multi-media messaging), photo file transfer, enterprise software applications, social media applications, video-gaming, streaming video or audio services, and podcasts.

### Example Devices

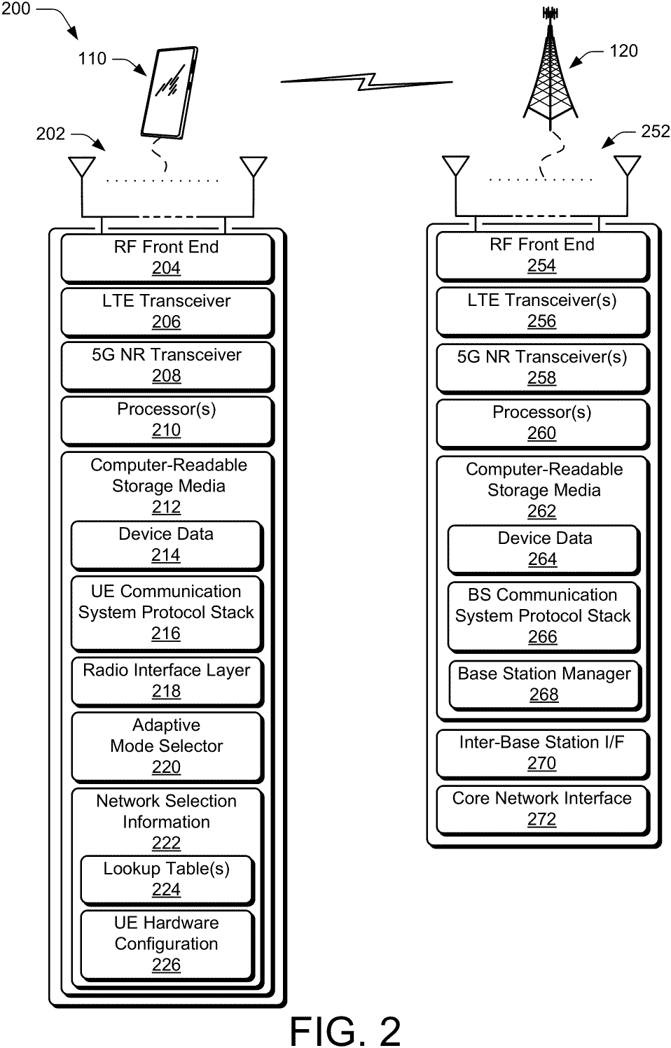

FIG. 2 illustrates an example device diagram 200 of the UE 110 and base stations 120. Generally, the device diagram 200 describes network entities that can implement various aspects of adaptive selection of a network access mode by a user equipment. FIG. 2 shows respective instances of the UE 110 and the base stations 120. The UE 110 or the base stations 120 may include additional functions and interfaces that are omitted from FIG. 2 for the sake of visual brevity. The UE 110 includes antennas 202, a radio frequency front end 204 (RF front end 204), and radio-frequency transceivers, shown as an LTE transceiver 206 and a 5G NR transceiver 208, that form a user equipment radio interface (UE radio interface) for communicating with base stations 120 in the RAN 140. The RF front end 204 of the UE 110 can couple or connect the LTE transceiver 206 and the 5G NR transceiver 208 to the antennas 202 to facilitate various types of wireless communication.

The antennas 202 of the UE 110 may include an array of multiple antennas that are configured similarly to, or differently from, each other. The antennas 202 and the RF front end 204 can be tuned to, and/or be tunable to, one or more frequency bands defined by the 3GPP LTE and 5G NR communication standards and implemented by the LTE transceiver 206 and/or the 5G NR transceiver 208. Additionally, the antennas 202, the RF front end 204, the LTE transceiver 206, and/or the 5G NR transceiver 208 may be configured to support beamforming for the transmission and reception of communications with the base stations 120. By way of example and not limitation, the antennas 202 and the RF front end 204 can be implemented for operation in sub-gigahertz (GHz) bands, above 1 GHz bands, sub-6 GHz bands, and/or above 6 GHz bands that are defined by the 3GPP LTE and 5G NR communication standards (e.g., 57-64 GHz, 28 GHz, 38 GHz, 71 GHz, 81 GHz, or 92 GHz bands).

The UE 110 also includes processor(s) 210 and computer-readable storage media 212 (CRM 212). The processor 210 may be a single-core processor or a multiple-core processor implemented with a homogenous or heterogeneous core structure. The computer-readable storage media described herein excludes propagating signals. CRM 212 may include any suitable memory or storage device such as random-access memory (RAM), static RAM (SRAM), dynamic RAM (DRAM), non-volatile RAM (NVRAM), read-only memory (ROM), or Flash memory useable to store device data 214 of the UE 110. The device data 214 includes any combination of user data, multimedia data, codebook(s), applications, and/or an operating system of the UE 110. In implementations, the device data 214 stores processor-executable instructions that are executable by processor(s) 210 to enable user-plane communication, control-plane signaling, and user interaction with the UE 110.

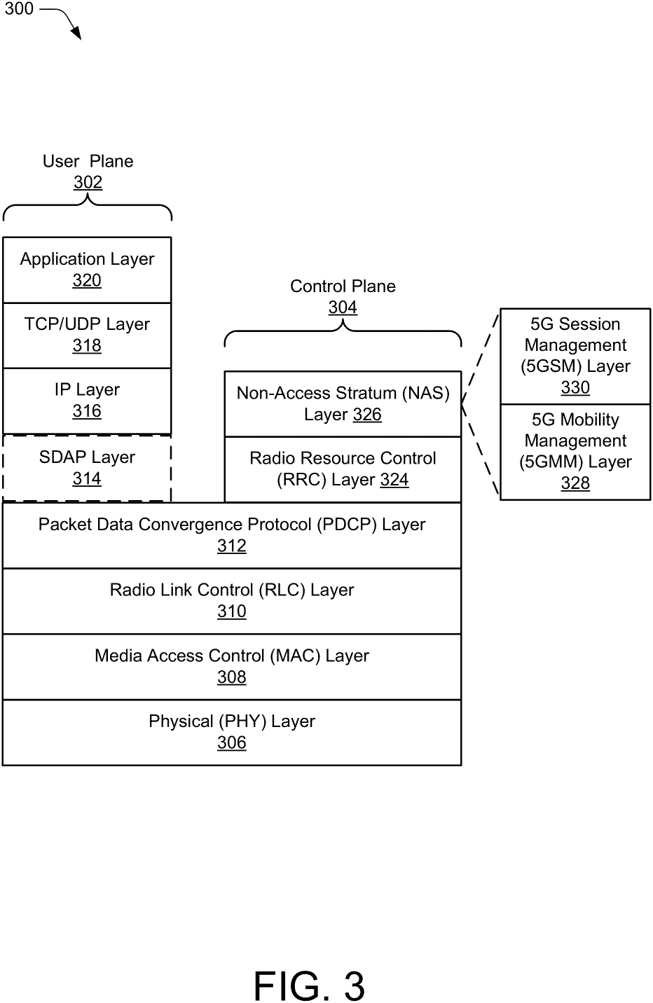

The CRM 212 of the UE 110 includes a UE communication system protocol stack 216 (UE protocol stack 216). Alternatively, or additionally, the UE protocol stack 216 may be implemented in whole or part as hardware logic or circuitry integrated with or separate from other components of the UE 110. In aspects, the UE protocol stack 216 of the UE 110 implements how devices in a communication system exchange information, such as by implementing multiple layers that act as entities for communication with another device using the protocols defined for the layer as further described with reference to FIG. 3.

The CRM 212 of the UE 110 includes a radio interface layer 218 (RIL 218). Alternatively, or additionally, the RIL 218 may be implemented in whole or part as hardware logic or circuitry integrated with or separate from other components of the UE 110. In aspects, the RIL 218 of the UE 110 provides access to the UE protocol stack 216, services supported by the UE protocol stack 216, and/or radio hardware used to implement the service. For instance, the RIL 218 provides Application Programming Interfaces (APIs) that applications or other types of logic use to obtain various types of information from the UE protocol stack 216, such as measurement reports generated by the UE protocol stack 216, network configuration information, Public Land Mobile Network (PLMN) identification information, and so forth. As another example, the RIL 218 provides APIs that direct the UE protocol stack 216 to initiate network procedures, such as a cell re-selection network procedures, a cell selection network procedures, detach network procedures, attach network procedures, a tracking area update (TAU) network procedure, and/or a connection release network procedure as further described.

The CRM 212 of the UE 110 includes an adaptive network access mode selector 220 (adaptive mode selector 220). Alternatively, or additionally, the adaptive mode selector 220 may be implemented in whole or part as hardware logic or circuitry integrated with or separate from other components of the UE 110. In aspects, the adaptive mode selector 220 of the UE 110 analyzes network selection information 222 and selects a network access mode that better satisfies operational performance metric(s) of the UE 110, such as a data throughput metric, data-transfer latency metric, or power consumption. As used herein, an operational performance metric may refer to any suitable measure of the functioning (in other words, the performance) of the UE 110. A network access mode analysis may be performed to determine one or more operational performance metrics for various network access modes provided by a RAN (and supported by the UE 110), such as a first cellular network access mode (e.g., SA) and a second cellular network access mode (e.g., NSA). The network access mode analysis may thus allow the UE to determine in which of the multiple network access modes the UE functions better (in other words, which network access mode allows the UE to have better performance). To illustrate, the adaptive mode selector 220 uses the RIL 218 to obtain network information, such as PLMN information, Cell identification (ID) information, a mobile network code (MNC), a mobile country code (MCC), and/or a tracking area code (TAC), and selects a lookup table (e.g., from lookup table(s) 224 included in the network selection information 222) or an entry in the lookup table using the network information. In aspects, the lookup table includes deployment configuration information of a RAN that the adaptive mode selector 220 analyzes as further described. The adaptive mode selector 220 alternatively or additionally accesses UE-hardware-configuration information associated with the UE 110 and determines potential or available operational performance metrics of various network access modes based on a combination of the deployment configuration and UE-hardware-configuration information. In some aspects, the adaptive mode selector 220 obtains measurement reports that indicate the frequencies (5G higher frequency signals, 4G lower frequency signals) that are currently available. In some aspects, the adaptive mode selector uses the available frequencies to identify changes in a current UE location, such as by monitoring for changes in received power levels to identify when the UE 110 moves away or towards a base station, and/or a current coverage area by identifying when high-band, mid-band, and/or low-band signals are available as further described. The adaptive mode selector 220 then determines potential or available operational performance metrics of various network access modes based on a combination of the deployment configuration, the UE-hardware-configuration information, and the current location and selects the network access mode that better provides or satisfies an operation performance metric to the UE 110.

At times, the adaptive mode selector 220 analyzes the network access modes based on a prioritization of multiple operational performance metrics. To illustrate, the adaptive mode selector 220 selects a first network access mode based on a first operational performance metric (e.g., data throughput) having higher priority than a second operational performance metric (e.g., data-transfer latency). The adaptive mode selector 220 calculates potential operational performance metrics for each available network access mode and selects the network access mode that provides better operational performance relative to other network access modes. However, based on determining that each network access mode provides commensurate (e.g., within a threshold value to one another, or within a common range) operational performances, the adaptive mode selector 220 sometimes selects the network access mode on the next-highest-priority operational performance metric. Alternatively, or additionally, based on identifying commensurate operational performances, the adaptive mode selector 220 selects a default network access mode, such as a default network access mode that corresponds to a newer, more advanced network access mode.

The CRM 212 of the UE 110 includes network selection information 222 that generally represents any combination of information that the adaptive mode selector 220 analyzes to determine/select a network access mode for the UE 110. To illustrate, the network selection information 222 can include prioritization information (not illustrated) that specifies a prioritization of operational performances. In the device diagram 200, the network selection information 222 includes one or more lookup table(s) 224 that indicate deployment configurations of a RAN and UE-hardware-configuration information 226 (UE hardware configuration 226) that specifies hardware capabilities of the UE 110. Alternatively, or additionally, the network selection information 222 includes measurement report information (not illustrated) and/or network system information (not illustrated), such as PLMN information (e.g., MNC, MCC, TAC, Cell-ID), obtained from the UE protocol stack 216 by way of the RIL 218.

At times, the UE 110 receives the lookup table(s) 224 from the base station 120, such as over a control channel, and stores the lookup tables 224 in the CRM 212. Alternatively, or additionally, the UE 110 obtains the lookup tables through manufacturing or installation processes that store the lookup tables 224 in the CRM 212 of the UE 110 during assembly, installation, or through an operator manually adding the lookup tables. Similarly, the UE 110 obtains the UE hardware configuration 226 through manufacturing or installation processes that store the UE hardware configuration 226 in the CRM 212 as further described.

The device diagram for the base stations 120, shown in FIG. 2, includes a single network node (e.g., a gNode B). The functionality of the base stations 120 may be distributed across multiple network nodes or devices and may be distributed in any fashion suitable to perform the functions described herein. The base stations 120 include antennas 252, a radio frequency front end 254 (RF front end 254), one or more LTE transceivers 256, and one or more 5G NR transceivers 258 that form a base station radio interface (BS radio interface) for communicating with the UE 110. The RF front end 254 of the base stations 120 can couple or connect the LTE transceivers 256 and the 5G NR transceivers 258 to the antennas 252 to facilitate various types of wireless communication. The antennas 252 of the base stations 120 may include an array of multiple antennas that are configured similarly to, or differently from, each other. The antennas 252 and the RF front end 254 can be tuned to, and/or be tunable to, one or more frequency bands defined by the 3GPP LTE and 5G NR communication standards, and implemented by the LTE transceivers 256 and/or the 5G NR transceivers 258. Additionally, the antennas 252, the RF front end 254, the LTE transceivers 256, and the 5G NR transceivers 258 may be configured to support beamforming, such as Massive-MIMO, for the transmission and reception of communications with the UE 110.

The base stations 120 also include processor(s) 260 and computer-readable storage media 262 (CRM 262). The processor 260 may be a single-core processor or a multiple-core processor composed of a variety of materials, such as silicon, polysilicon, high-K dielectric, copper, and so on. CRM 262 may include any suitable memory or storage device such as random-access memory (RAM), static RAM (SRAM), dynamic RAM (DRAM), non-volatile RAM (NVRAM), read-only memory (ROM), or Flash memory useable to store device data 264 of the base stations 120. The device data 264 includes network scheduling data, radio resource management data, applications, and/or an operating system of the base stations 120, which are executable by processor(s) 260 to enable communication with the UE 110.

In aspects, the CRM 262 of the base station 120 also includes a base station-communication system protocol stack 266 (BS protocol stack 266). Alternatively, or additionally, the BS protocol stack 266 may be implemented in whole or part as hardware logic or circuitry integrated with or separate from other components of the base station 120. At times, the BS protocol stack 266 communicates with the UE protocol stack 216 using complementary operations, such as that described with reference to FIG. 3.

The CRM 262 also includes a base station manager 268. Alternatively, or additionally, the base station manager 268 may be implemented in whole or part as hardware logic or circuitry integrated with or separate from other components of the base station 120. In at least some aspects, the base station manager 268 configures the LTE transceivers 256 and the 5G NR transceivers 258 for communication with the UE 110, as well as communication with a core network, such as the core network 150.

The base station 120 includes an inter-base station interface 270, such as an Xn and/or X2 interface, which the base station manager 268 configures to exchange user-plane and control-plane data between another base station 120, to manage the communication of the base stations 120 with the UE 110. The base station 120 also includes a core network interface 272 that the base station manager 268 configures to exchange user-plane data and control-plane information with core network functions and/or entities.

### Example Protocol Stack

FIG. 3 illustrates an example block diagram of a wireless network stack model 300 (stack 300) in which various aspects of informing an upper layer of barring alleviation for multiple access classes can be implemented. The stack 300 characterizes a communication system for the example environment 100, in which various aspects of adaptive selection of a network access mode by a user equipment can be implemented. The stack 300 includes a user plane 302 and a control plane 304. Upper layers of the user plane 302 and the control plane 304 share common lower layers in the stack 300. Wireless devices, such as the UE 110 or the base station 120, implement each layer as an entity for communication with another device using the protocols defined for the layer. For example, a UE 110 uses a Packet Data Convergence Protocol (PDCP) entity to communicate to a peer PDCP entity in a base station 120 using the PDCP.

The shared lower layers include a physical (PHY) layer 306, a Media Access Control (MAC) layer 308, a Radio Link Control (RLC) layer 310, and a PDCP layer 312. The PHY layer 306 provides hardware specifications for devices that communicate with each other. As such, the PHY layer 306 establishes how devices connect to each other, assists in managing how communication resources are shared among devices, and the like.

The MAC layer 308 specifies how data is transferred between devices. Generally, the MAC layer 308 provides a way in which data packets being transmitted are encoded and decoded into bits as part of a transmission protocol.

The RLC layer 310 provides data transfer services to higher layers in the stack 300. Generally, the RLC layer 310 provides error correction, packet segmentation, and reassembly, and management of data transfers in various modes, such as acknowledged, unacknowledged, or transparent modes.

The PDCP layer 312 provides data transfer services to higher layers in the stack 300. Generally, the PDCP layer 312 provides the transfer of user plane 302 and control plane 304 data, header compression, ciphering, and integrity protection.

Above the PDCP layer 312, the stack splits into the user-plane 302 and the control-plane 304. Layers of the user plane 302 include an optional Service Data Adaptation Protocol (SDAP) layer 314, an Internet Protocol (IP) layer 316, a Transmission Control Protocol/User Datagram Protocol (TCP/UDP) layer 318, and an application layer 320, which transfers data using the interface 106. The optional SDAP layer 314 is present in 5G NR networks. The SDAP layer 314 maps a Quality of Service (QoS) flow for each data radio bearer and marks QoS flow identifiers in uplink and downlink data packets for each packet data session. The IP layer 316 specifies how the data from the application layer 320 is transferred to a destination node. The TCP/UDP layer 318 is used to verify that data packets intended to be transferred to the destination node reached the destination node, using either TCP or UDP for data transfers by the application layer 320. In some implementations, the user plane 302 may also include a data services layer (not shown) that provides data transport services to transport application data, such as IP packets including web-browsing content, video content, image content, audio content, or social media content.

The control plane 304 includes a Radio Resource Control (RRC) layer 324 and a Non-Access Stratum (NAS) layer 326. The RRC layer 324 establishes and releases connections and radio bearers, broadcasts system information, or performs power control. The RRC layer 324 also controls a resource control state of the UE 110 and causes the UE 110 to perform operations according to the resource control state. Example resource control states include a connected state (e.g., an RRC connected state) or a disconnected state, such as an inactive state (e.g., an RRC inactive state) or an idle state (e.g., an RRC idle state). In general, if the UE 110 is in the connected state, the connection with the base station 120 is active. In the inactive state, the connection with the base station 120 is suspended. If the UE 110 is in the idle state, the connection with the base station 120 is released. Generally, the RRC layer 324 supports 3GPP access but does not support non-3GPP access (e.g., WLAN communications).

The NAS layer 326 provides support for mobility management (e.g., using a Fifth-Generation Mobility Management (5GMM) layer 328) and packet data bearer contexts (e.g., using a Fifth-Generation Session Management (5GSM) layer 330) between the UE 110 and entities or functions in the core network, such as an Access and Mobility Management Function of the 5GC 151 or the like. The NAS layer 326 supports both 3GPP access and non-3GPP access.

In the UE 110, each layer in both the user plane 302 and the control plane 304 of the stack 300 interacts with a corresponding peer layer or entity in the base station 120, a core network entity or function, and/or a remote service, to support user applications and control operation of the UE 110 in the RAN 140.

### Adaptive Selection of a Network Access Mode by a User Equipment

Evolving wireless technologies support multiple network access modes as a way to improve various operational performance metrics of a corresponding network, such as data throughput, data-transfer latencies, signal strength, and so forth. As one example, assume RAN 140 of FIG. 1 includes support for a 5G standalone (SA) network access mode and a non-standalone (NSA) network access mode. When operating in the SA network access mode, the UE 110 communicates in the RAN using a single RAT (e.g., 5G only). While operating in the NSA network access mode, the UE 110 communicates in the RAN using multiple RATs (e.g., 5G and 4G).

A network operator of a RAN oftentimes assigns a default network access mode to a UE. To illustrate, the network operator may assign the SA (cellular) network access mode to a UE that supports both SA and NSA to reduce the use of 4G air interface resources, to migrate more devices to 5G SA, or to provide the UE with lower data-transfer latency. However, the network access mode selected by the network operator may not always provide the UE with an optimal or desired operational performance. To illustrate, the network operator may assign a default network access mode to every UE that supports multiple network access modes. However, the efficacy of the default network access mode can vary at each UE based on a combination of factors, such as a deployment configuration of a RAN, UE-hardware-configuration information, and a UE location.

FIG. 4 illustrates a line graph 400 that shows an example coverage deployment timeline in accordance with various aspects of adaptive selection of a network access mode by a user equipment. The line graph 400 shows example resource partitioning between various network access modes at a RAN (e.g., 4G, 5G NSA, 5G SA) over time. At 2019, the RAN uses a first deployment configuration that primarily supports 4G communications based on 4G being a mature network access mode relative to the 5G SA and 5G NSA network access modes. In the first deployment configuration, the RAN allocates a smaller portion of the available 4G air-interface resources to 5G NSA communications (e.g., 5G NSA communications that utilize portions of the 4G air-interface resources), most available 5G air interface resources to 5G NSA communications, and little-to-no 5G air interface resources to 5G SA communications.

As 5G matures, the RAN uses different deployment configurations that reassign the air-interface resources to different network access modes and/or deploys support for additional air-interface resources. For instance, at 2020, the RAN uses a second deployment configuration that reassigns air-interface resources used for 4G communications in the first deployment configuration to 5G NSA communications and deploys additional support for 5G SA communications. This reassignment and/or support continues as 5G matures and the RAN deploys more support for 5G SA and 5G NSA. Thus, the RAN uses a third deployment configuration at 2021 and a fourth deployment configuration at 2022, where the deployment configurations progressively reassign more air interface resources from 4G communications to 5G NSA communications, deploy more support for a maturing 5G SA, and/or reassign 5G air-interface resources used for 5G NSA communications to 5G SA communications. Thus, a RAN may deploy different deployment configurations over time. These varying deployment configurations also change the efficacy of the network access modes at a UE. In aspects of adaptive selection of a network access mode by a user equipment, a UE evaluates the potential operational performance of multiple network access modes and selects a network access mode better suited to priorities at the UE. The UE then initiates a change to the selected network access mode.

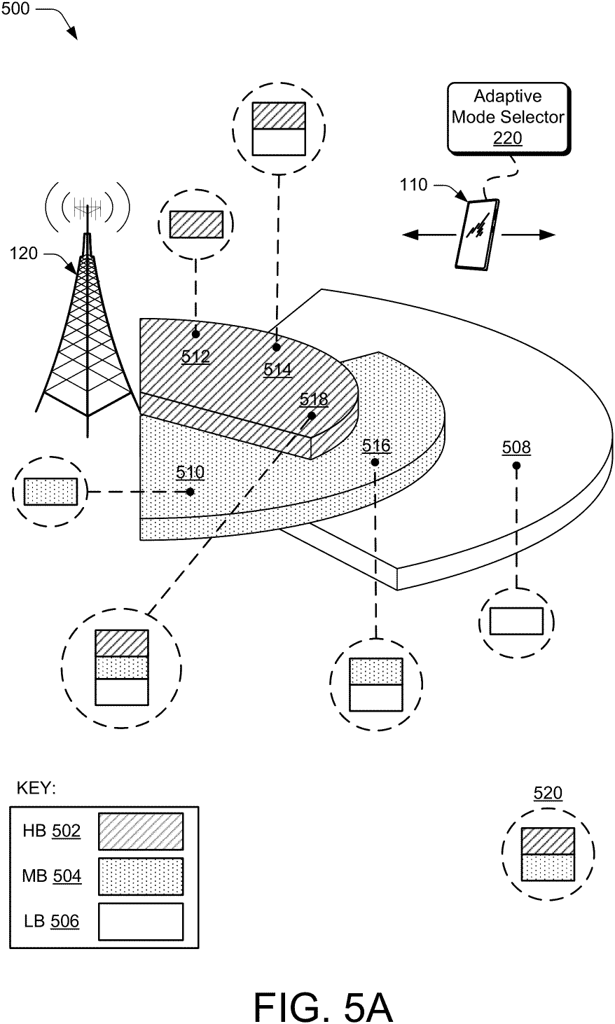

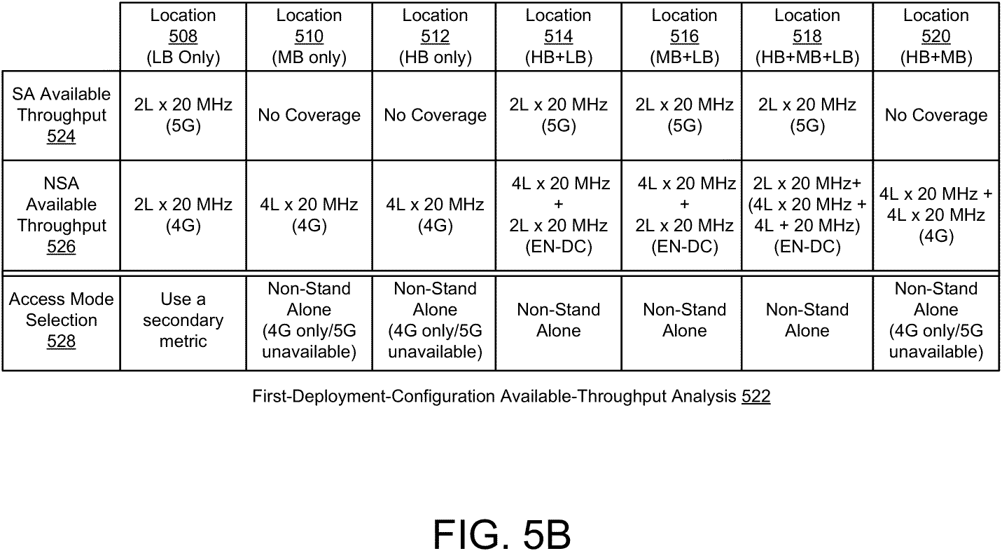

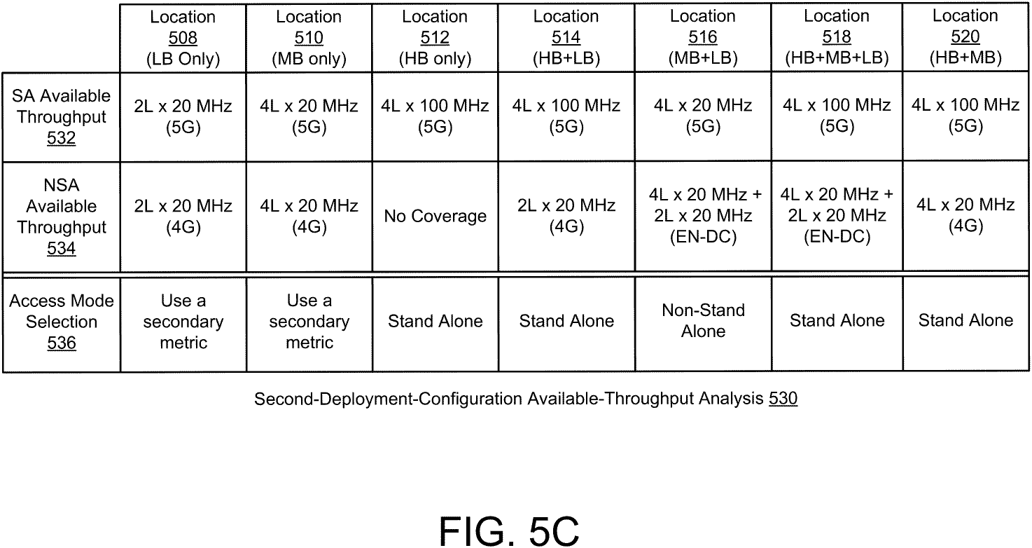

FIGS. 5A-5C illustrate an example environment 500 and corresponding analyses in which adaptive selection of a network access mode by a user equipment is implemented in accordance with various aspects. The environment 500 includes the base station 120 of FIG. 1 and schematics of three different coverage areas provided by the base station 120. More particularly, as indicated by the key, the environment includes schematics for a first coverage area 502 (e.g., a high-band (HB) coverage area in line hash marks), a second coverage area 504 (e.g., a mid-band (MB) coverage area in dotted hash marks), and a third coverage area 506 (e.g., a low-band (LB) coverage area in white). The coverage areas 502, 504, and 506 may be generally aligned directionally extending from the base station 120 along one axis (not shown) or directed in different directions along different axes as shown in FIG. 5A. Alternatively or additionally, a respective angular sweep of each coverage area 502, 504, and/or 506 may vary from one another, with directionality and/or angular sweep varying in some cases varying based on a particular antenna array through which one or more RAT services are provided by the base station 120.

The coverage area 502 corresponds to a high-band coverage area of the base station 120, where wireless communications occur in a first frequency band. To illustrate, in 5G, the coverage area 502 corresponds to wireless communications that operate in the above 6 GHz (mmWave) band. In the high-band coverage area, and using communications in the above 6 GHz band, the base station 120 provides the highest data throughput and/or lower data-transfer latencies relative to the coverage areas 504 and 506, but over a shorter radial distance or more-limited coverage range. 5G-capable UEs located within the coverage area 502 can communicate with the base station using high-band communications and access the higher data throughput and/or lower data-transfer latencies.

The coverage area 504 corresponds to a mid-band coverage area of the base station where wireless communications occur in a second frequency band. To illustrate, in 5G, the coverage area 504 corresponds to wireless communications that operate in the above 1 GHz band (e.g., 2 GHz - 6 GHz). In the mid-band coverage area, the base station 120 can provide access to wireless communications over a larger distance or greater range, but at a lower data throughput, relative to the coverage area 502. However, relative to the coverage area 506, the base station 120 provides a higher data throughput over a smaller radial distance in the coverage area 504.

The coverage area 506 corresponds to a low-band coverage area of the base station 120, where wireless communications occur in a third frequency band. To illustrate, in 5G, the coverage area 506 corresponds to wireless communications that operate in sub-GHz bands. In the low-band coverage area, the base station 120 provides access to wireless communications over the largest radial distance and geographic range, but with the lowest data throughput, of the coverage areas 502, 504, and 506.

The potential operational performance (e.g., data throughput, data-transfer latency, power consumption) at each coverage area can also depend on a deployment configuration utilized by the RAN for the corresponding wireless technology. For example, in a first deployment configuration of a wireless technology, such as an early-stage deployment of a wireless technology or a deployment configuration of a first network operating in a first region, a RAN may provide less air interface resources (e.g., frequency bands, frequency carriers, time durations, symbols) to a first network access mode (e.g., SA) relative to a second access mode (e.g., NSA). To illustrate, and with reference to FIG. 4, in a first deployment configuration of 5G SA, a RAN may provide limited air interface resources for 5G SA communications such that a potential operational performance in each coverage area (e.g., low-band, mid-band, high-band) remains commensurate. A second deployment configuration, such as a later stage of deployment of the wireless technology or a deployment configuration of a second network operating in a second region, the RAN may provide more air interface resources to 5G SA communications, such as by reassigning air interface resources used for 5G NSA communications to 5G SA communications as further described. This can result in each coverage area having a different potential operational performance from one another. Thus, the location of the UE and varying deployment configurations of a wireless technology affect which access mode better addresses a UE’s service needs.

The environment 500 also includes the UE 110 of FIG. 1, where the UE 110 moves about, and between, the various coverage areas provided by the base station 120. Because the base station 120 deploys the coverage areas 502, 504, and 506 with varying positions and sizes, the UE 110 receives different services from the base station 120 at different locations. To illustrate, when positioned at location 508, the UE 110 only gains access to services deployed (by the base station 120) using low-band communications because neither the coverage area 502 or the coverage area 504 overlap with the coverage area 506 at location 508. Similarly, at location 510 the UE 110 only gains access to services deployed using mid-band communications, and only services deployed using high-band communications at location 512, based on the lack of any other overlapping coverage areas at these locations. However, at location 514, because (only) the coverage area 502 and the coverage area 506 overlap, the UE 110 potentially gains access to services provided using high-band and low-band communications. At location 516, because (only) the coverage area 504 and the coverage area 506 overlap, the UE 110 potentially gains access to services provided using mid-band and low-band communications. At location 518, because each of the coverage areas 502, 504, and 506 overlap, the UE 110 potentially gains access to services provided using high-band, mid-band, and low-band communications. While not illustrated in the example environment 500, some implementations include locations where (only) the coverage area 502 and the coverage area 504 overlap, generally indicated by location 520.

In aspects, the adaptive mode selector 220 of the UE 110 determines whether a current network access mode assigned to the UE 110 provides the UE 110 with an operational performance better than other available (and supported) network access modes, or whether to initiate a change to a different network access mode. For example, the adaptive mode selector 220 analyzes a deployment configuration of the base station 120 in combination with UE-hardware-configuration information, a current UE location, and/or prioritization information. As the UE 110 moves, such as between any combination of the locations 508, 510, 512, 514, 516, 518, and/or 520, the adaptive mode selector 220 may reevaluate a current network access mode to determine if a switch in network access modes better suits the UE 110.

To illustrate, assume the UE 110 prioritizes data throughput higher than other operational performance metrics. As the UE moves, the adaptive mode selector 220 evaluates at least the deployment configuration provided by each network access mode available at a respective location and selects a preferred network access mode that provides better data throughput relative to other network access modes. To illustrate, the adaptive mode selector 220 accesses a lookup table (e.g., lookup table 224 of FIG. 2) that indicates the deployment configuration of the RAN and/or a UE-hardware-configuration information (e.g., UE hardware configuration 226 of FIG. 2) and determines which network access mode provides the UE 110 with better data throughput at a current location. However, the adaptive mode selector 220 can alternatively or additionally evaluate the network access modes based on different operational performance metrics (e.g., power consumption, latency) or a combination of operational performance metrics as further described.

FIG. 5B illustrates a first-deployment-configuration available-throughput analysis 522 (analysis 522). The analysis 522 shows example analysis results of a network access mode analysis generated and/or determined by the adaptive mode selector 220 based on the varying locations (e.g., locations 508, 510, 512, 514, 516, 518, 520) of FIG. 5A, where adaptive mode selector performs the network access mode analysis based on available data throughput to the UE 110. To illustrate, the adaptive mode selector 220 determines a first deployment configuration used by a RAN, such as through a lookup table (not illustrated) that indicates a deployment configuration of a current RAN and/or resources allocated to each network access mode. For example, the adaptive mode selector 220 obtains PLMN information and selects a lookup table that corresponds to the PLMN information. As another example, the adaptive mode selector 220 analyzes measurement reports that indicate available frequency bands based on power levels and determines what network access modes are available (e.g., 4G and 5G frequency bands, only 4G bands, only 5G low-bands, 5G mid-bands, 5G high-bands) and/or the supported frequencies in each frequency band at a current location. Alternatively, or additionally, the adaptive mode selector 220 analyzes UE-hardware-configuration information (not illustrated) to determine if UE hardware capabilities affect the operational performance.

The analysis 522 generated by the adaptive mode selector 220 compares available data throughput provided by a 5G SA network access mode (shown in row 524), and a 5G NSA network access mode (shown in row 526) for the locations 508, 510, 512, 514, 516, 518, 520. Row 528 of the analysis 522 also indicates the network access mode selection made by the adaptive mode selector 220 based on the throughput information. Further, the specific locations shown in the analysis 522 generally correspond to any commensurate location with same coverage qualities (e.g., LB only, MB only, HB only, HB+MB, MB+LB, HB+MB+LB, HB+MB).

Assume for a first deployment configuration, a RAN only deploys low-band Frequency Division Duplex (FDD) for 5G SA communications. In other words, the RAN only supports 5G low-band communications and does not include support for 5G mid-band or high-band communications. In aspects, low-band FDD 5G SA communications correspond to 20-megahertz (MHz) throughput and 2-layer Multiple Input, Multiple Output (MIMO), labeled as 2 L × 20 MHz. Also assume that the maximum hardware capabilities of the UE 110 support the 5G 2 L × 20 MHz communications but the UE only supports one stand-alone band at a time (e.g., only high-band, only mid-band, only low-band). Additionally, in the first deployment configuration, for 4G mid-band communications, the RAN supports four layers of MIMO at a 20 MHz throughput (4 L × 20 MHz) and for 4G high-band communications, the RAN supports 4 L × 20 MHz throughput. Based on analyzing the first deployment configuration and/or the UE-hardware-configuration information and as shown in row 524, the adaptive mode selector 220 determines that the SA network access mode provides the UE 110 with (potentially) 2 L × 20 MHz data throughput at positions that include LB coverage, such as the location 508, the location 514, the location 516, and the location 518. In other words, even though the locations 514, 516, and 518 include overlapping 5G coverage areas, the RAN only supports the low-band coverage area 506, which results in the UE 110 only receiving services provided by low-band communications when operating in the SA network access mode. The locations 510, 512, and 520 do not overlap with the low-band coverage area 506. Thus, because the RAN does not support mid-band or high-band communications in the first-deployment configuration, the locations 510, 512, and 520 have no 5G coverage and subsequently no stand-alone coverage.

As shown in row 526, the adaptive mode selector 220 also analyzes the available data throughput for the UE 110 in the NSA network access mode using any combination of deployment configuration information, UE-hardware-configuration information, UE location, and so forth, based on the varying locations (e.g., locations 508, 510, 512, 514, 516, 518, 520) of FIG. 5A. When operating in the NSA network access mode, the UE can access resources provided by both 5G and 4G, thus increasing the potential data throughput relative to the 5G SA network access mode. To illustrate, at some locations and based on the overlapping coverage areas, a UE operating in the NSA network access mode can establish contemporaneous 4G and 5G connections with one or more base stations to increase data throughput for uplink or downlink user-plane data. Alternatively or additionally, when operating in the NSA network access mode, the UE may only operate using a single RAT, such as in locations that only support/include 4G communications and do not support/lack 5G communications (e.g., locations 510, 512, and 520 in the first deployment configuration)

For instance, based on the first deployment configuration, a UE operating in the NSA network access mode can establish a first connection using 4G carrier aggregation (CA), which, as further described, provides 4 L × 20 MHz throughput in the (high-band) coverage area 502 at the location 514 and 4 L × 20 MHz throughput in the (mid-band) coverage area 504 at the location 516 . Combining the first (4G CA) connection (e.g., 4 L × 20 MHz at the location 514 or the location 516) with a second 5G connection (e.g., overlapping low-band FDD with a potential of 2 L × 20 MHz) yields potentially a three-times data throughput improvement over the SA network access mode. Therefore, at the locations 514 and 516 that correspond to the low-band coverage area overlapping with the high-band coverage area or the mid-band coverage area, respectively, the adaptive mode selector 220 determines that an NSA network access mode selection (shown in row 528 under locations 514 and 516) better suits a data throughput performance metric relative to the SA network access mode.

Similarly, at the location 518, a UE operating in the NSA network access mode has access to 4G CA that supports eight layers of MIMO at a 20 MHz throughput (8 L × 20 MHz) based on aggregating the throughput of the mid-band communications and high band communications. Combining a 4G CA connection with a 5G connection (e.g., overlapping low-band FDD with a potential of 2 L × 20 MHz) yields potentially a five-times data throughput improvement over the SA network access mode. Therefore, at the location 518 where the high-band coverage area 502, the mid-band coverage area 504, and the low-band coverage area 506 all overlap, the adaptive mode selector 220 determines that a NSA network access mode selection (shown in row 528 under location 518) better suits a data throughput performance metric relative to the SA network access mode.

At the location 508, however, where the distance between the UE and the base station is greater, the resulting RF capabilities of 4G technologies diminish any potential performance improvements received from combining a 4G connection with a 5G connection. Accordingly, a UE located in the low-band coverage area and operating in the NSA network access mode has access to the same potential performance capabilities (e.g., data throughput) as when operating in the SA network access mode. Because the potential performance capabilities for the SA and NSA network access modes are equivalent at the location 508, some implementations of the adaptive mode selector determine the network access mode selection based on a secondary metric, such as a data-transfer latency metric or a power consumption metric. Alternatively, or additionally, the adaptive mode selector 220 selects a default network access mode, such as a default network access mode that corresponds to a newer, more advanced network access mode. In some aspects, the adaptive mode selector 220 determines to retain the current network access mode and/or to not initiate a change to another network access mode because of a lack of operational performance improvement.

At the locations 510, 512, and 520, the RAN lacks support for mid-band and high-band communications. This results in no 5G coverage. Accordingly, the adaptive mode selector 220 selects the NSA network access mode as indicated in the row 528 under the location 510, the location 512, and the location 520, where the NSA network access mode operates using only 4G communications because 5G communications are unavailable at these locations.

For clarity, the analysis 522 shown in FIG. 5B includes analyses for both network access modes in the high-band coverage area, the mid-band coverage area, and the low-band coverage area. In some aspects, the adaptive mode selector 220 generates an analysis for a single coverage area. To illustrate, assume the adaptive mode selector 220 obtains UE location information from the UE protocol stack 216 and/or a Global Navigation Satellite System (GNSS) and determines that a current location corresponds to the mid-band coverage area 504. Based on determining that the UE 110 currently resides in the mid-band coverage area of the base station 120 that does not overlap with any high-band coverage area, the adaptive mode selector 220 may only generate analyses for the network access modes in the mid-band and low- band coverage areas.

FIG. 5C illustrates a second-deployment-configuration available-throughput analysis 530 (analysis 530). The analysis 530 shows example results of a network access mode analysis generated and/or determined by the adaptive mode selector 220 based on a second example deployment configuration used by a RAN, such as a second deployment stage of the wireless technology or a deployment configuration used by a second network operating in a second region. For purposes of this patent application, a schematic of the second region used for the analysis 530 is presumed equivalent to the schematic of the first region used for the analysis 522. In other implementations, the second region could have more, the same number, or fewer coverage areas than the first region and differently-sized or shaped overlapping sections. Similarly to the analysis 522, the adaptive mode selector 220 evaluates available data-throughput for a 5G SA network access mode (shown in row 532) and a 5G NSA network access mode (shown in row 534 for the locations 510, 512, 514, 516, 518, 520 that generally correspond to any commensurate location with same coverage qualities (e.g., LB only, MB only, HB only, HB+MB, MB+LB, HB+MB+LB, HB+MB). The analysis 530 also includes, in row 536, an access mode selection made by the adaptive mode selector 220.

In the second deployment configuration, the RAN provides different capabilities to the UE in the different coverage areas relative to the first deployment configuration. As one example, in the second deployment configuration, the RAN disallows NSA dual-connectivity, such as E-UTRA-New Radio-Dual Connectivity (EN-DC), using above 6 GHz communications in the high-band coverage area. In other words, in locations that include overlapping coverage areas with the high band coverage area 502, the second deployment configuration allows NSA dual-connectivity using mid- and low-band 5G communications but disallows dual-connectivity using high-band 5G communications. Instead, the second deployment configuration reassigns the resources used for high-band 5G communications to SA. Also assume that for the analysis 530, and similar to that described with reference to the analysis 522, the UE 110 only supports one stand-alone band at a time (e.g., only high-band, only mid-band, or only low-band).

Based on analyzing the second deployment configuration and/or the UE-hardware-configuration information, the adaptive mode selector 220 determines that, at the location 508, each network access mode provides the UE 110 with equivalent data throughput (e.g., 2 L × 20 MHz). Accordingly, in the second deployment configuration and at the location 508, and similarly to the analysis 522, the adaptive mode selector 220 determines the network access mode using a secondary metric as shown in row 536. Alternatively, or additionally, the adaptive mode selector 220 selects a default network access mode or determines to retain the current network access mode as further described.

The locations 510 and at the location 516 correspond to (only) the mid-band coverage area 504, and the mid-band coverage area 504 overlapping with the low-band coverage area 506, respectively. Like the first deployment configuration, in the NSA network access mode, the UE can establish contemporaneous connections that include a first connection using 4G carrier aggregation and a second 5G connection. For the second deployment configuration, the RAN provides 4 L dynamic spectrum sharing (DSS) that can result in 4 L × 20 MHz throughput in the mid-band coverage area 504. As shown by the analysis 530, the adaptive mode selector 220 determines that, at the location 510, the RAN provides a same throughput to the UE 110 in the SA network access mode (e.g., 4 L × 20 MHz based on 100% DSS allocation to 5G) and the NSA network access mode (e.g., 4 L × 20 MHz based on 100% DSS allocation to 4G). Accordingly, at the location 510, the adaptive mode selector 220 determines to use a secondary metric to select the network access mode. At the location 516, the RAN potentially provides more data throughput performance to the UE 110 when operating in the NSA network access mode (e.g., 4 L × 20 MHz based on 100% DSS mid-band allocation to 4G combined with 2 L × 20 MHz low-band 5G) relative to the SA network access mode (e.g., 4 L × 20 MHz based on 100% DSS mid-band allocation to 5G).

For the high-band coverage area of the second deployment configuration, the RAN disallows NSA dual-connectivity with high-band 5G communications and redirects the 5G high-band communication resources to SA communications. The location 512 corresponds a location that only includes high-band coverage. Because the second deployment configuration disallows dual-connectivity with high band communications, the NSA network access mode becomes unavailable in the high-band only coverage area and the adaptive mode selector 220 selects the SA network access mode as indicated in the row 536. At the locations 514, 518, and 520, where the high-band coverage area 502 overlaps with other coverage areas, the adaptive mode selector 220 determines that (a) the SA network access mode provides the UE 110 with more resources relative to the first deployment configuration (e.g., 4 L × 100 MHz) and (b) the SA network access mode provides more data throughput relative to the NSA network access mode (where high-band communications for dual connectivity has been disallowed) as indicated in row 536 under the columns corresponding to the location 514, the location 518, and the location 520. To illustrate, the adaptive mode selector 220 analyzes the network access modes using any combination of UE-hardware-configuration information, deployment configuration information, UE-location, and so forth, to determine a data throughput operational performance metric for each network access mode. Thus, as shown in FIGS. 5B and 5C, the deployment configuration of a RAN, as well as UE location, UE hardware configurations, and prioritizations, affect which network access mode better suits a UE.

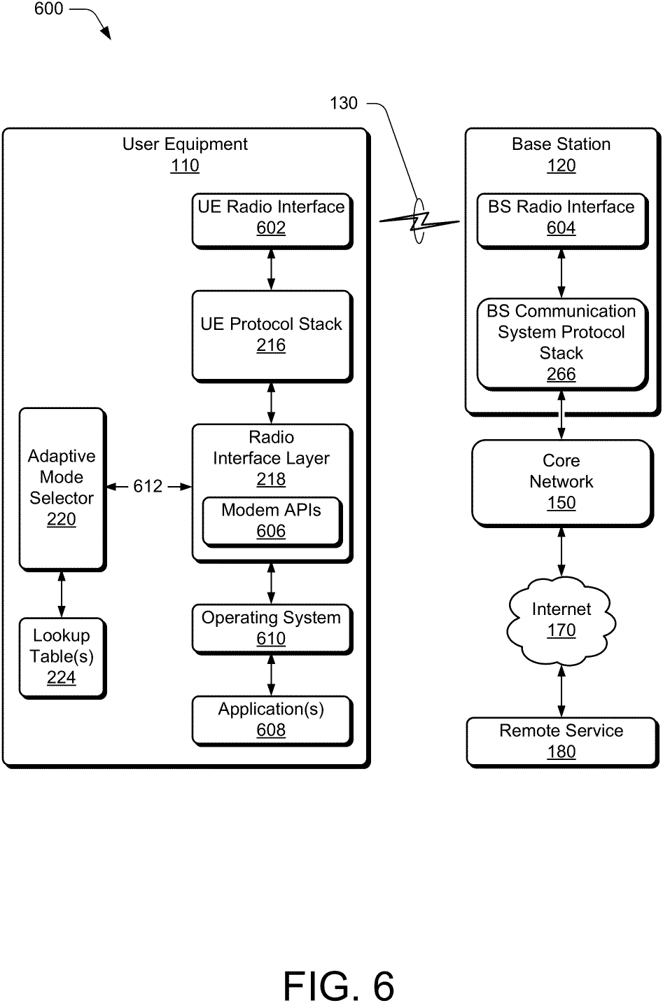

FIG. 6 illustrates an example environment 600 in which adaptive selection of a network access mode by a user equipment is implemented in accordance with various aspects. The environment 600 includes the UE 110, the base station 120, and the core network 150 of FIG. 1. In aspects, the environment 600 illustrates an example architecture used for adaptive selection of a network access mode by a user equipment.

The UE 110 includes a user equipment radio interface 602 (UE radio interface 602) that includes the antennas 202, the RF front end 204, the LTE transceiver 206, and the 5G NR transceiver 208 of FIG. 2. As shown, the UE protocol stack 216 interacts with the UE radio interface 602 to communicate wirelessly with the base station 120 over the wireless link 130. Similarly, the base station 120 includes a base station radio interface 604 (BS radio interface 604) that includes the antennas 252, the RF front end 254, the LTE transceivers 256, and the 5G NR transceivers 258 of FIG. 2. The BS protocol stack 266 interacts with the BS radio interface 604 to communicate wirelessly with the UE 110 over the wireless link 130. As further described, layers and/or entities in the UE protocol stack 216 communicate with corresponding layers and/or entities in the BS protocol stack 266. As one example, the BS protocol stack 266 requests measurement reports from the UE protocol stack 216, such as by transmitting a measurement configuration information element. For instance, the BS protocol stack 266 transmits a measConfig information element (IE) as defined by 3GPP TS 38.331 to the UE 110. The UE protocol stack 216 then generates and transmits a measurement result information element, such as a measResults IE, as defined by 3GPP TS 38.331, back to the BS protocol stack 266. As another example, the base station 120 indicates cell re-selection information, such as by transmitting the indications in system information blocks (SIBs), and the UE 110 performs various measurements based on the cell re-selection information.

In some aspects, the base station 120 and the UE 110 exchange system information. To illustrate, the base station 120 transmits PLMN information that includes an MNC and/or an MCC in a system information block (SIB). The UE 110, by way of the UE protocol stack 216, monitors for SIB transmissions and extracts the MNCs or MCC from the SIB. In some cases, the UE 110 uses the MNCs and/or MCC to select and/or access the lookup table 224 to identify the deployment configuration of the RAN 140 as further described.

The RIL 218 of the UE 110 provides applications or other forms of logic with access to the UE protocol stack 216. To illustrate, the RIL 218 includes modem application programming interfaces 606 (modem APIs 606) that provide the applications or other forms of logic a layer of abstraction in communicating with the UE protocol stack 216. For instance, the modem APIs 606 provide interfaces that allow the applications to request actions (e.g., network procedures) or information (e.g., measurement results, MNC, MCC) from the UE protocol stack 216 in a manner that protects the UE protocol stack 216 from disruptions. As one example, an application 608 and/or the operating system 610 use the modem APIs 606, and subsequently, the UE protocol stack 216 to communicate with the remote service 180 by way of the Internet 170. As another example, the adaptive mode selector 220 uses the modem APIs 606 to obtain information from the UE protocol stack 216 (e.g., measurement results, system information) and to indicate selected network access modes to the RAN, such as by initiating network procedures.

In aspects, the adaptive mode selector 220 monitors network information and/or measurement reports to detect a trigger event that indicates to perform a network access mode analysis, such as a trigger event corresponding to a change in location that the adaptive network mode selector 220 identifies through a change in Cell-ID or a change in power levels of frequency bands. To illustrate, the adaptive mode selector 220 monitors the network information and/or measurement reports using the modem APIs 606. To illustrate, the adaptive mode selector 220 receives the network information from the UE protocol stack 216, such as MCC information, MNC information, TAU information, a received signal strength indicator (RSSI), a reference signal receive quality (RSRQ), a reference signal receive power (RSRP), a signal-to-interference-plus-noise ratio (SINR), serving frequency information, beam-level measurement results, frequency band lists, and so forth. At 612, the adaptive mode selector 220 periodically polls the UE protocol stack 216 or registers (and receives asynchronously) receive notifications of measurement report updates using the modem APIs 606. In some aspects, the adaptive mode selector 220 polls or registers to receive notifications of UE location changes, and requests system information and/or measurement information when the UE location changes by a threshold value.

In some aspects, and based on receiving the network information, the adaptive mode selector 220 accesses one or more lookup tables 224 to obtain the supported capabilities, such as by using the MNC and/or the MCC. As another example, the adaptive mode selector 220 analyzes measurement reports that indicate available frequency bands based on power levels and determines what network access modes are available (e.g., 4G and 5G frequency bands, only 4G bands, only 5G low-bands, 5G mid-bands, 5G high-bands) and/or the supported frequencies in each network access modes at a current location. In some cases, the adaptive mode selector 220 selects the network access mode based on a prioritization of performance metrics. This can include using default prioritizations of the performance metrics (e.g., prioritize data throughput higher than data-transfer latency) or prioritizations based on a current state of the UE 110.

To illustrate, assume the application 608 receives large quantities of data from the remote service 180 by way of the Internet 170 and the base station 120. For visual brevity, the communication path illustrated between the UE 110 and the remote service 180 omits various layers and/or features, such as network layers that encapsulate communications from the protocol stack 266 to the remote service 180 and vice versa. In analyzing the measurements, system information, and/or a lookup table to determine a network access mode, the adaptive mode selector 220 prioritizes data throughput higher than data-transfer latency. Based on this prioritization, the adaptive mode selector 220 selects a first network access mode instead of a second network access mode based on determining the first network access mode has a higher (potential) data throughput. As another example, assume the application 608 requires low data-transfer latency. Based on identifying this prioritization, the adaptive mode selector 220 selects the second network access mode based on the second network access mode providing (potentially) lower data-transfer latencies relative to the first network access mode.

For instance, assume the adaptive network access mode selector 220 prioritizes data throughput over data-transfer latency. Based on analyzing signal and/or link quality parameters, the adaptive mode selector 220 identifies that the UE is operating in a coverage area that provides 5G high-frequency (e.g., above 6 GHz) band communications. Based on available frequency bands and the prioritization, the adaptive mode selector 220 determines to indicate to the RAN that the UE supports NSA to maximize data throughput. However, in response to identifying that the RAN disallows NSA dual-connectivity with 5G high-frequency communications (e.g., from lookup table(s) 224), the adaptive mode selector 220 determines to indicate support of SA (only) to the RAN.

As another example, based on available frequency bands, the adaptive mode selector 220 identifies that the UE is operating in a coverage area that only provides 5G low-band FDD communications. Alternatively, or additionally, the adaptive mode selector also identifies that the NSA network access mode and the SA network access mode provide commensurate performance (e.g., from lookup table(s) 224) based on a current location of the UE. Accordingly, the adaptive mode selector 220 determines to indicate to the RAN that the UE supports SA, without indicating support for the NSA network access mode, to potentially obtain lower data-transfer latencies or to indicate support for a wireless technology identified by the lookup table as being a newer and/or evolving wireless technology.

In some cases, the adaptive mode selector 220 determines the network access mode based on multiple priorities. With reference to the analysis 522 and the analysis 530, the RAN provides a UE operating in the low-band coverage area (that extends past the mid-band coverage area and the high-band coverage area) with similar data throughput for both the SA network access mode and the NSA network access mode. In response to identifying that all the available network access modes provide a similar operational performance for the first priority performance metric (e.g., data throughput), the adaptive mode selector 220 analyzes the network access modes based on a second performance metric (e.g., data-transfer latency) and selects the network access mode based on the second performance metric.

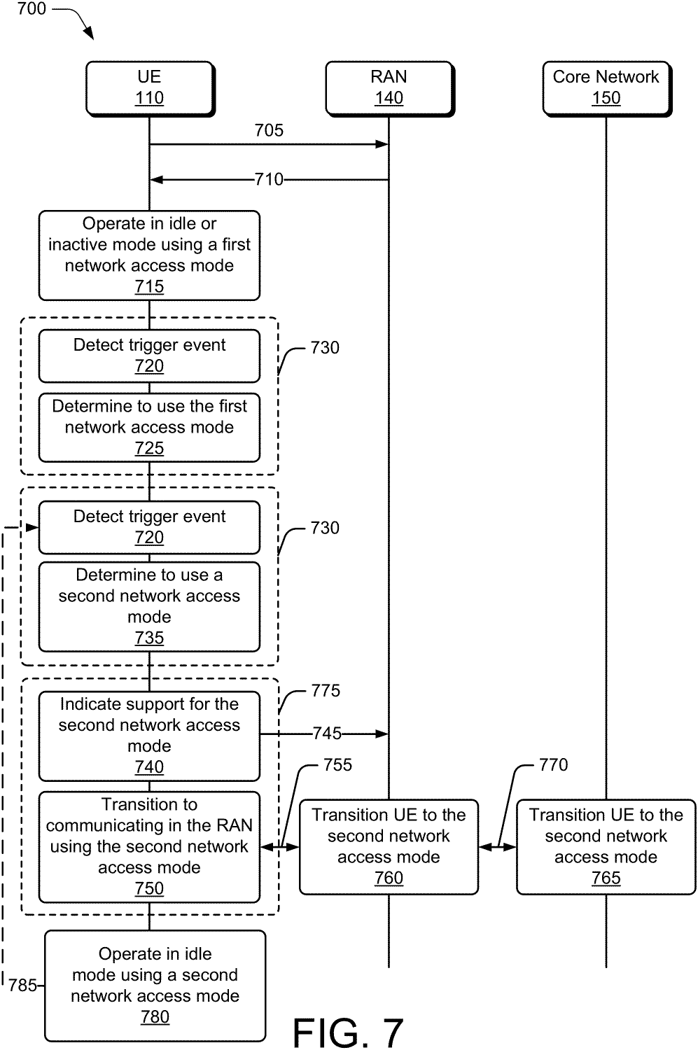

The adaptive mode selector 220 communicates the selected network access mode to the UE protocol stack 216, such as by using the modem APIs 606. Alternatively, or additionally, the adaptive mode selector 220 initiates a network procedure that indicates the selected network access mode to the base station 120. As one example, the adaptive mode selector 220 initiates, through the modem APIs 606, a detach/attach network procedure, a tracking area update (TAU) network procedure, and/or a connection release network procedure prior to initiating the TAU network procedure as described with reference to FIGS. 7-11. As part of performing the network procedure(s), the UE 110, by way of the UE protocol stack 216, indicates the selected network access mode to the RAN by way of the base station 120.

To illustrate, assume the UE 110 has at least attached to the base station 120 or has established a connection to the base station 120. While attached or connected, the UE 110 and base station 120 exchange various communications with one another to perform various network procedures, such as detach/attach network procedures or a TAU network procedure. In aspects, as part of exchanging communications with the base station 120, the UE 110 transmits UE capabilities to inform the base station 120 of the features supported by the UE. To illustrate, the UE 110 transmits a user-equipment-capability-information information element (UECapabilityInformation IE) as described in 3GPP TS 38.331 v15.6.0 (2019-06), section 5.6.1, 6.2.2, and 6.3.3, where the UE protocol stack 216 configures the UECapabilityInformation IE based on the selected network access mode. For example, to indicate support for NSA as directed by the adaptive mode selector 220, the protocol stack 216, configures the UECapabilityInformation IE to include a user-equipment-multi-radio-access-technology-dual-connectivity-capability information-element (UE-MRDC-Capability IE), and omit a user-equipment-new-radio-capability information-element (UE-NR-Capability IE), as described in 3GPP TS 38.331 v15.6.0 (2019-06) section 6.3.3. Thus, the inclusion of the UE-MRDC-Capability IE implicitly indicates support for the NSA network access mode, and the omission of the UE-NR-Capability IE implicitly indicates that SA is not supported.

To indicate support for SA as directed by the adaptive mode selector 220, the protocol stack 216 configures the UECapabilityInformation IE to include a UE-NR-Capability IE, and omit a UE-MRDC-Capability IE, as described in 3GPP TS 38.331 v15.6.0 (2019-06) section 6.3.3. Thus, the inclusion of the UE-NR-Capability IE implicitly indicates support for the SA network access mode, and the omission of the UE-MRDC-Capability IE implicitly indicates that NSA is not supported. Alternatively, or additionally, the UE protocol stack 216 explicitly indicates the UE 110 does not support a network access mode (e.g., SA, NSA), such as through the use of a Boolean value, a flag, an enumeration type value, and so forth. In some aspects, the adaptive mode selector 220 selects, and the UE protocol stack 216 indicates, that the UE 110 supports multiple network access modes (s, SA, and NSA).

The base station 120, by way of the BS protocol stack 266, analyzes the UE capabilities and identifies a network access mode supported by the UE 110. For instance, the BS protocol stack 266 determines that the UE 110 supports the NSA network access mode by identifying the inclusion of a UE-MRDC-Capability IE in the UECapabilityInformation IE, and determines that the UE 110 supports the SA network access mode by identifying the inclusion of a UE-NR-Capability IE in the UECapabilityInformation IE. The base station 120 then configures and/or reconfigures the wireless link 130 using protocols and/or air interface resources associated with the indicated network access mode. Alternatively, or additionally, the base station 120 forwards the UE capabilities to the core network 150 for evaluation, and the core network 150 directs the RAN to establish a wireless connection with the UE 110 based on the indicated network access mode.

By obtaining and analyzing information from the UE protocol stack, a UE, by way of an adaptive network access mode selector, can select a network access mode better suited to provide the UE with higher performance relative to other network access modes. This allows the UE to override a current network access mode and/or direct the selection of a new network access mode to improve system performance based on the capabilities and/or priorities of the UE.

### Signaling and Control Transactions

FIGS. 7, 8, 9, 10, and 11 illustrate example signaling and control transaction diagrams 700, 800, 900, 1000, and 1100, respectively. The diagrams 700 and 1100 illustrate example signaling and control transactions between various network entities, such as the UE 110, the RAN 140 (that includes and communicates through the base stations 120), and the core network 150 (that communicates with the UE 110 through the RAN 140) in accordance with aspects of adaptive selection of a network access mode by a user equipment. The diagrams 800, 900, and 1000 illustrate example transactions between entities within the UE 110, such as the adaptive mode selector 220 and the UE protocol stack 216. The UE 110, the RAN 140, and the core network 150 may be implemented using any combination of aspects described with reference to FIGS. 1-6.

A first example of signaling and control transactions for adaptive selection of a network access mode by a user equipment is illustrated by the signaling and control transaction diagram 700 of FIG. 7. In the diagram 700, a UE operating in an idle or inactive mode, such as a radio resource control idle mode (RRC_IDLE) or a radio resource control inactive mode (RRC_INACTIVE), adaptively determines to use a second network access mode that is different from a current (first) network access mode and initiates a change in the current network access mode to the RAN.

As illustrated, the UE 110 transmits a first indication 705 that the UE 110 supports multiple network access modes to the RAN 140. To illustrate, assume that the UE 110 supports both SA and NSA network access modes. As part of an access registration procedure, the UE 110 indicates, to the RAN, that the UE supports both network access modes, such as by transmitting a UECapabilityInformation IE that indicates support for both SA and NSA as further described. In aspects, the RAN 140 and the UE 110 both support multiple network access modes. At times, the core network 150 includes multiple core networks (e.g., 5GC 151, EPC 152), where one of the core networks acts as an anchor or network controller for network access modes that communicate using multiple RATs.

Based on receiving the indication that the UE 110 supports both network access modes, the RAN 140 selects a first network access mode and transmits directions 710 to the UE 110 that indicate to operate in the RAN using the first network access mode. As one example, the RAN 140 transmits, by way of the base station 120, an RRC Reconfiguration message that indicates to use the first network access mode.

At 715, the UE 110 operates in an idle or inactive mode while using the first network access mode as directed by the RAN 140. To illustrate, based on completing the access registration procedure, the UE 110 sometimes transitions to an RRC INACTIVE mode. Alternatively, or additionally, after a period of inactivity, the UE 110 transitions to an RRC IDLE mode. While operating in the idle or inactive mode, the UE 110 communicates with the RAN 140, such as by monitoring downlink signals that convey information (e.g., PLMN information, broadcast system information, cell re-selection information, paging information).

To illustrate, the UE 110 establishes a wireless link with the base station 120 by using a first protocol and a first set of air interface resources associated with the first network access mode (e.g., 5G NSA network access mode, 5G SA network access mode). This can include the UE 110 communicating with a single base station (e.g., base station 121) while operating in an SA network access mode, or communicating with multiple base stations (e.g., base station 121, base station 122) while operating in an NSA network access mode. In aspects, the protocol and air interface resources used while operating in the NSA network access mode includes both 5G and 4G protocols and air interface resources. Using the first protocol and first set of air interface resources, the base station 120 transmits signaling information and/or communications to the UE 110, such as minimum system information (SI) and/or other system information blocks (SIBs) that include cell-reselection information. In some aspects, the cell re-selection information indicates, to the UE 110, a request to perform particular measurements (e.g., particular measurements for particular frequencies and/or frequency bands). Alternatively, or additionally, the base station 120 transmits PLMN information to the UE 110.

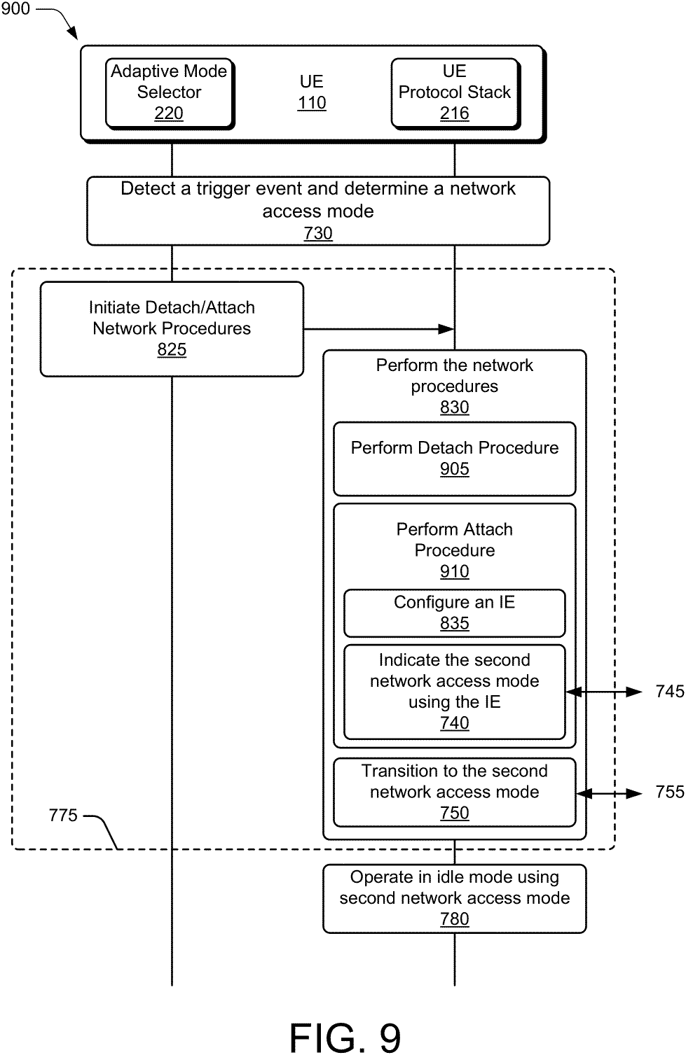

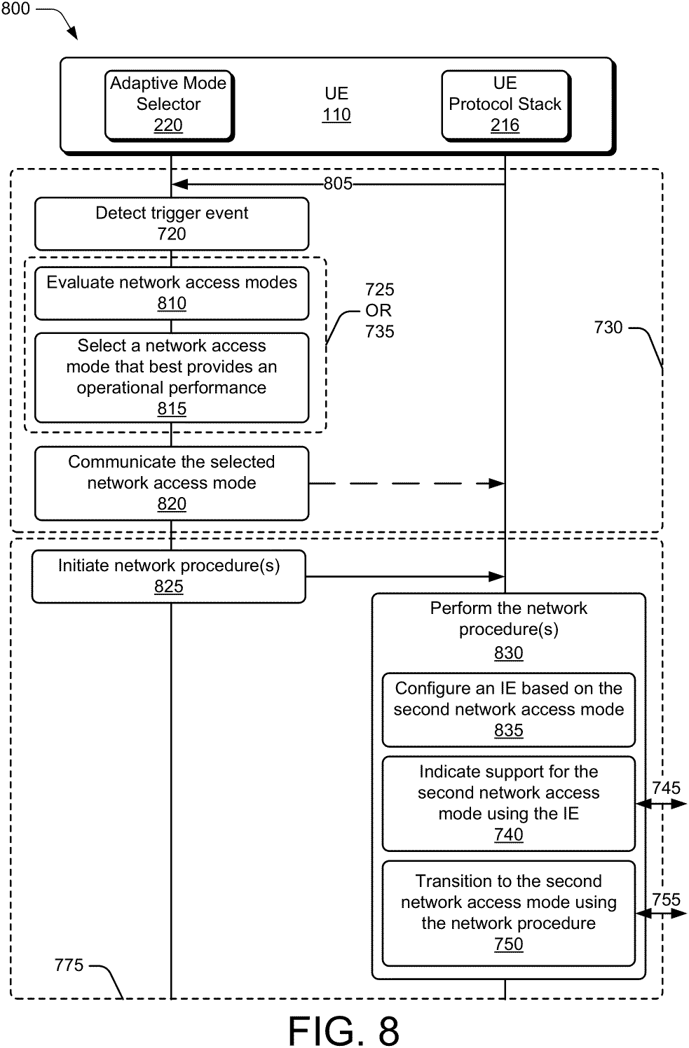

At 720, the UE 110 detects a first trigger event that indicates to perform a network access mode analysis. To illustrate, assume the UE 110 generates measurement reports as directed by the base station 120 through the cell-reselection information or a measConfig IE. The UE 110 analyzes the measurement reports and detects a trigger event that corresponds to the UE 110 moving locations. For example, the adaptive mode selector 220 analyzes the measurement reports to identify the available frequencies and determines that a location change has occurred when the available frequencies have changed. As another example, the adaptive mode selector 220 analyzes the measurement reports to identify changes in received power levels to identify when UE 110 moves away (e.g., lower power levels) or towards (e.g., higher power levels) a base station. In some aspects, the adaptive mode selector 220 analyzes the measurement reports to determine a current coverage area, such as by identifying when high-band, mid-band, and/or low-band signals are available as further described. Based on detecting the first trigger event, the UE 110 performs the network access mode analysis. To illustrate, the UE 110 analyzes the first network access mode as described with reference to FIG. 8 and determines to use the first network access mode at 725 instead of switching to a different network access mode. To illustrate, the UE 110 analyzes deployment configurations of the available network access modes provided by the RAN 140 (and supported by the UE 110) and determines to remain in the first network access mode.

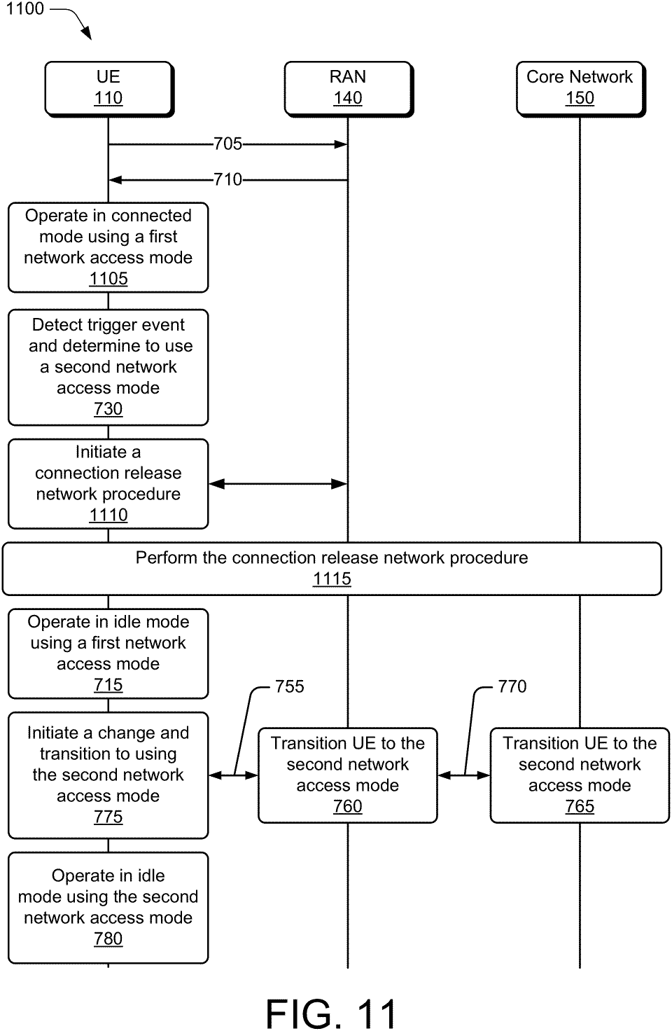

Generally, the transactions performed at 720 and 725 correspond to a first instance of a sub-diagram 730 in which the UE 110 detects a trigger event and determines a network access mode that better suits the UE 110 based on operational performance(s) as further described. The sub-diagram 730 can include alternative or additional actions, such as those described with reference to FIG. 8, to detect a trigger event and determine a network access mode that better suits the UE 110. At times, the UE 110 uses the actions of the sub-diagram 730 when operating in a connected mode, such as that described with reference to FIG. 11.

A second instance of the sub-diagram 730 includes the transactions at 720, where the UE 110 detects a second trigger event that indicates to perform a second network access mode analysis (e.g., the UE 110 again changes locations), and at 735, where the UE 110 determines to use a second network access mode based on the second network access mode analysis. At 735, the UE 110 determines to use the second network access mode based on a determination that the second network access mode better suits operational performance(s) as described with reference to FIG. 8. For example, the UE 110 determines to use the second network access mode based on a comparison of at least one operational performance metric of the second network access mode with a respective operational performance metric of the first network access mode.

At 740, the UE indicates, to the RAN, that the UE supports the second network access mode and indicates a preference for the second network access mode, such as that described with reference to FIGS. 8, 9, and 10. For example, the UE 110 transmits a second indication 745 that implicitly and/or explicitly indicates which network access modes the UE supports, such as through message and/or information element (IE) configurations as further described. In some aspects, the UE indicates that the UE supports the second network access mode and/or a preference for the second network access mode by not indicating that the UE supports the first network access mode. As another example, the UE indicates a preference for the second network access mode by indicating a prioritization of the second network access mode over the first network access mode. Thus, in aspects, the indication 745 differs from the indication 705 insofar as the UE does not indicate support for both network access modes even though the UE does support both network access modes and/or the UE indicates a preferred network access mode (e.g., through prioritization). By indicating only the second network access mode, the UE 110 causes the RAN 140 to reconfigure the connection with the UE to a connection implemented using the second network access mode.

At 750, the UE 110 transitions to communicating in the RAN using the second network access mode. In transitioning to communicating in the RAN using the second network access mode, the UE 110 can exchange signaling and/or control information 755 with the RAN 140 and/or the core network 150, such as by exchanging signaling and/or control information used to perform network procedures (e.g., detach/attach/reselection network procedure, a TAU network procedure). Accordingly, the RAN 140 transitions the UE 110 to the second network access mode at 760, and the core network 150 transitions the UE 110 to the second network access mode at 765. This can include the RAN 140 and/or the core network 150 exchanging messaging 770 with one another. To illustrate, a first core network, such as the EPC 152 of FIG. 1, acts as an anchor or network controller that manages communications with the UE 110 when the UE 110 operates in an NSA network access mode. In transitioning the UE 110 to the second network access mode, the first core network may exchange messages with a second core network (e.g., 5GC 151) and/or base stations in the RAN 140 to transition the UE 110 to the second core network.

Generally, the sub-diagram 775 illustrates example actions performed by the UE 110 and/or signaling and control transactions exchanged to initiate a change that transitions the UE 110 from communicating in the RAN using a first network access mode to communicating in the RAN using a second network access mode. The sub-diagram 775 can include alternative or additional transactions, such as those described with reference to FIGS. 8, 9, and 10, to transition to a different network access mode.

At 780, and based on transitioning to communicating in the RAN using the second network access mode, the UE 110 operates in the idle mode while using the second network access mode. For example, the UE 110 uses a second protocol and a second set of air interface resources associated with, or specific to, the second network access mode (e.g., 5G SA network access mode, 5G NSA network access mode) and communicates with the RAN 140 and/or the core network 150 as further described.

In some aspects, the UE 110 intermittently and/or periodically determines to adapt the network access mode from the second network access mode to another network access mode as indicated at 785. For example, while operating in the idle mode at 780, the UE 110 detects a third trigger event at 720, evaluates the network access modes based on the updated network selection information, and determines to use a different network access mode than the second network access mode.

A second example of signaling and control transactions for adaptive selection of a network access mode by a user equipment is illustrated by the signaling and control transaction diagram 800 of FIG. 8. The diagram 800 includes a first set of example transactions performed by the UE 110 that can be used to implement the sub-diagram 730 of FIG. 7, and a second set of example transactions performed by the UE 110 to implement the sub-diagram 775 of FIG. 7. The sub-diagrams 730 and 775 can include additional transactions that are omitted for visual brevity.

As illustrated, the adaptive mode selector 220 obtains one or more measurement reports 805 from the UE protocol stack 216, such as measurement reports generated by the UE protocol stack 216 based on cell re-selection information obtained from the RAN 140 or a measConfig IE. Alternatively, or additionally, the adaptive mode selector 220 obtains network information, such as PLMN information that includes MNC, MCC, and/or TAU information. This can include obtaining the measurement reports and/or network information periodically or asynchronously as further described. In aspects, the adaptive mode selector 220 uses the modem APIs 606 to poll, or register with, the UE protocol stack 216 for the measurement reports and/or network information.

At 720, the adaptive mode selector 220 detects a trigger event as described with reference to FIG. 7. At 810, based on detecting the trigger event, the adaptive mode selector 220 evaluates the network access modes. To illustrate, the adaptive mode selector 220 selects and accesses a lookup table (e.g., lookup table 224) using the MNC, MCC, and/or TAU information to obtain a deployment configuration of the RAN 140. Alternatively, or additionally, the adaptive mode selector 220 analyzes the measurement reports to identify what frequency bands are available and determine a deployment configuration (e.g., high-band frequencies available, mid-band frequencies available, low-band frequencies available) at a current location. In some aspects, the adaptive mode selector 220 obtains, from the device data 214, UE-hardware-configuration information to determine if the UE has hardware capabilities that may result in performance limitations. In evaluating the network access modes, the adaptive network access mode sometimes prioritizes one or more operational performance metrics and evaluates the network access modes based on the prioritized performance metrics, such as the analysis described with reference to FIGS. 5A-5C in which the adaptive mode selector 220 determines available data throughput based on a deployment configuration, a current UE location, UE-hardware-configuration information, and a prioritization of operational performances.

At 815, the adaptive mode selector 220 selects a network access mode that provides better operational performance. For example, as described at 725 of FIG. 7, the adaptive mode selector 220 sometimes determines that a current network access mode better suits the UE 110 based on a specific metric such as throughput, latency, or power-efficiency. Other times, the adaptive mode selector 220 determines that a different network access mode better suits the UE 110 as described at 735 of FIG. 7. To illustrate, as described with reference to FIGS. 5A-5C, the adaptive mode selector 220 sometimes determines that a switch to a SA network access mode (or a switch to an NSA network access mode) better suits prioritized performance metrics.

At 820, the adaptive mode selector 220 optionally communicates the second network access mode to the UE protocol stack 216, such as through the modem APIs 606 of FIG. 6. Alternatively, or additionally, the adaptive mode selector 220 communicates the second network access mode to the UE protocol stack 216 when initiating a network procedure, such as one of the network procedures initiated at 825.

Based on determining to switch network access modes, the adaptive mode selector 220 initiates the change in network access modes. The sub-diagram 775 as shown in FIG. 8 illustrates example transactions internal to the UE 110 that can be used to initiate the change and transition the UE 110 from communicating in the RAN using a first network access mode to communicating in the RAN using a second network access mode.

At 825, the adaptive mode selector 220 initiates one or more network procedures through the UE protocol stack 216 to indicate that the UE supports the second network access mode. To illustrate, the adaptive mode selector uses the modem APIs 606 to direct the UE protocol stack 216 to initiate the network procedure in the RAN. In some aspects, the adaptive mode selector 220 optionally communicates the second network access mode to the UE protocol stack 216 when initiating one of the network procedure(s). The adaptive mode selector 220 initiates any combination of network procedures that result in the UE 110 communicating the second network access mode to the RAN 140 and/or core network 150, such as any combination of a detach network procedure, a cell selection network procedure, a cell re-selection network procedure, an attach network procedure, a TAU network procedure, and/or a connection release network procedure followed by a TAU network procedure as further described.

At 830, the UE protocol stack 216 performs the network procedure(s), such as by wirelessly communicating with the RAN 140 and/or the core network 150 through the BS protocol stack 266. At times, performing the network procedure(s) includes the exchange of multiple messages and/or signaling between the UE 110 and the RAN 140. In aspects, as part of performing the network procedure(s), the UE 110 indicates to the base station 120 that the UE 110 supports the second network access mode to the RAN 140 without indicating that the UE 110 supports the first network access mode, even though the UE 110 supports both the first and second network access modes. Based on indicating the second network access mode, and as part of performing the network procedure(s), the UE 110 transitions from the first network access mode to the second network access mode.

As one example, at 835 and as part of performing the network procedure(s), the UE protocol stack 216 configures an information element (IE) based on the second network access mode indicated at 820 or at 825. To illustrate, as part of the TAU network procedure or a detach/attach network procedure, the UE protocol stack 216 generates a UE capability information IE that includes capabilities specific to the second network access mode and omits capabilities specific to the first network access mode. For instance, the UE protocol stack 216 includes a UE-MRDC-Capability IE in a UECapabilityInformation IE to indicate that the UE 110 supports the NSA network access mode. Alternatively, or additionally, the UE protocol stack 216 omits a UE-NR-Capability IE in the UECapabilityInformation IE to implicitly indicate that the UE 110 does not support the SA network access mode or explicitly indicates the lack of support through a flag, Boolean type value, and so forth. As another example, the protocol stack 216 includes a UE-NR-Capability IE in the UECapabilityInformation IE to indicate that the UE 110 supports the SA network access mode. Alternatively, or additionally, the UE protocol stack 216 omits a UE-MRDC-Capability IE in the UECapabilityInformation IE to implicitly indicate that the UE 110 does not support the SA network access mode or explicitly indicates the lack of support through a flag, Boolean type value, and so forth.

At 740 and as part of performing the network procedure, the UE protocol stack 216 indicates that the UE supports the second network access mode. In some aspects, the UE protocol stack 216 indicates support for the second network access mode without indicating that the UE supports the first network access mode by transmitting the UECapabilityInformation IE configured at 835. Alternatively, or additionally, the UE protocol stack 216 indicates a preference for the second network access mode, such as by including prioritizations of the network access mode. The transmission of the UECapabilityInformation IE directs the RAN to establish a connection with the UE 110 using the indicated network access mode, such as by detaching a first connection with the UE 110 formed using a first protocol and a first set of air interface resources (e.g., specific to the first network access mode), and attaching to the UE 110 using a second connection formed using a second protocol and a second set of air interface resources (e.g., specific to the second network access mode). Accordingly, at 750, the UE 110 transitions, by way of the UE protocol stack 216, to the second network access mode by using and successfully completing the network procedure.

A third example of signaling and control transactions for adaptive selection of a network access mode by a user equipment is illustrated by the signaling and control transaction diagram 900 of FIG. 9. In aspects, the transactions shown in the diagram 900 can be combined with aspects of the signaling and control transactions described by the diagrams 700, 800, or 1100 of FIGS. 7, 8, and 11.

At 730, the UE 110, by way of the adaptive mode selector 220 and the UE protocol stack 216, detects a trigger event and determines to use a second network access mode. Based on determining to use the second network access mode, the UE 110, by way of the adaptive mode selector 220 and the UE protocol stack 216, initiates a change to the second network access mode as described by the sub-diagram 775, where the diagram 900 of FIG. 9 includes example transactions that can be performed as part of the sub-diagram 775. As one example, at 825, as part of initiating one or more network procedure(s), the adaptive mode selector 220 initiates a detach network procedure and an attach network procedure. In some aspects, the adaptive mode selector 220 communicates the second network access mode to the UE protocol stack 216 when initiating the network procedures.

At 830, based on receiving the indication to initiate the network procedures, the UE protocol stack 216 performs the network procedures. To illustrate, at 905, the UE protocol stack 216 initiates a detach network procedure.

Based on completing the detach network procedure, the UE protocol stack 216 performs an attach network procedure at 910. As part of performing the attach network procedure, the UE protocol stack 216 configures an IE based on the second network access mode at 835 and indicates the second network access mode to the RAN using the IE at 740. To illustrate, the UE protocol stack 216 initiates the transmission of the indication 745 (e.g., a UECapabilityInformation IE). The UE protocol stack 216 then transitions to the second network access mode at 750, which can include exchanging the signaling and/or control information 755 with the RAN 140 (not illustrated). Based on completing the detach/attach network procedure(s), the UE 110, by way of the UE protocol stack 216, operates in an idle mode using the second network access mode at 780.

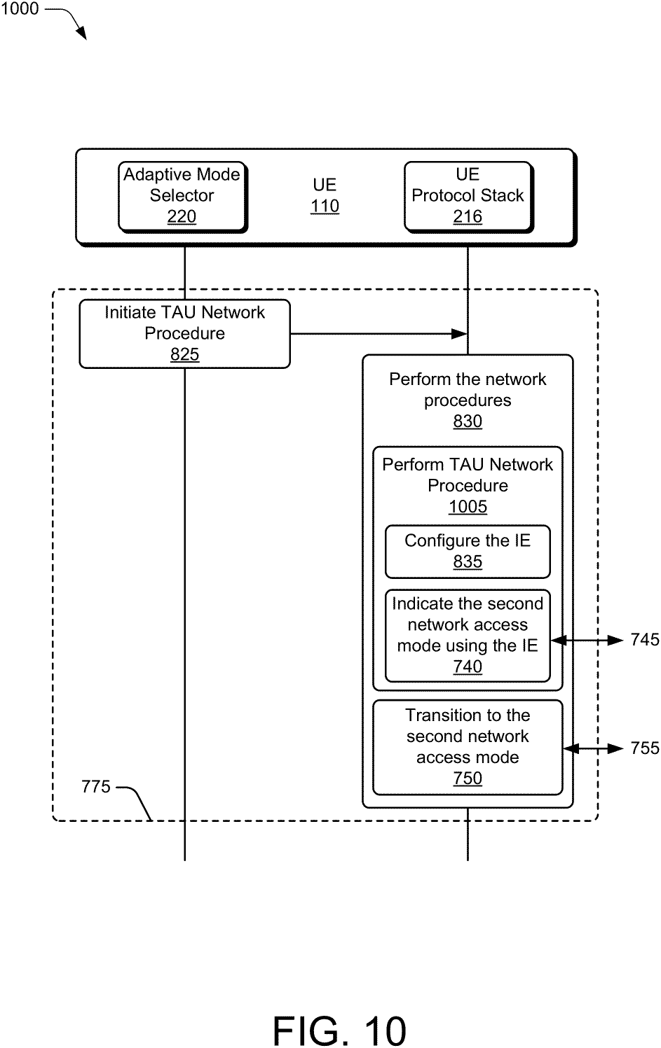

A fourth example of signaling and control transactions for adaptive selection of a network access mode by a user equipment is illustrated by the signaling and control transaction diagram 1000 of FIG. 10. In aspects, the transactions shown in the diagram 1000 can be combined with aspects of the signaling and control transactions described by the diagrams 700, 800, or 1100 of FIGS. 7, 8, and 11.

The diagram 1000 includes example transactions performed as part of the sub-diagram 775. For example, as part of initiating the network procedure(s) at 825, the adaptive mode selector 220 initiates a TAU network procedure as further described. In aspects, the adaptive mode selector 220 communicates the second network access mode determined using the sub-diagram 730 (not illustrated) to the UE protocol stack 216 as part of initiating the TAU network procedure.

Based on receiving directions from the adaptive mode selector 220, and as part of performing the network procedures at 830, the UE protocol stack 216 performs a TAU network procedure at 1005. As part of performing the TAU network procedure, the UE protocol stack 216 configures an IE based on the second network access mode at 835 and indicates the second network access mode to the RAN with the IE at 740, such as by transmitting the indication 745 to the RAN. The UE protocol stack 216 then transitions to the second network access mode at 750, which can include exchanging the signaling and/or control information 755 with the RAN 140 (not illustrated).

A fifth example of signaling and control transactions for adaptive selection of a network access mode by a user equipment is illustrated by the signaling and control transaction diagram 1100 of FIG. 11. In the diagram 1100, a UE operating in a connected mode, such as a radio resource control connected mode (RRC_CONNECTED), adaptively selects a network access mode and initiates a network procedure that adjusts the network access mode for the UE to the selected network access mode.

As illustrated, the UE 110 transmits a first indication 705 that the UE 110 supports multiple network access modes to the RAN 140. To illustrate, the UE 110 transmits an indication that the UE 110 supports both SA and NSA network access modes as further described.

Based on receiving the indication that the UE 110 supports both network access modes, the RAN 140 selects a first network access mode and transmits directions 710 to the UE 110 that indicate to operate in the RAN using the first network access mode. As one example, the RAN 140 transmits, by way of the base station 120, an RRC Reconfiguration message that indicates to use the first network access mode.

At 1105, the UE 110 operates in a connected mode while using the first network access mode as directed by the RAN 140. To illustrate, as part of the access registration procedure, the UE 110 sometimes transitions to an RRC CONNECTED mode. While operating in the connected mode, the UE 110 communicates with the RAN 140 (by way of the base station 120) using a first network access mode (e.g., using a first protocol and a first set of air interface resources associated with a first network access mode). This can include communicating with the core network 150 through the base station 120 included in the RAN 140. To establish the connected mode, the UE 110, the RAN 140, and/or the core network 150 (by way of the base station 120) exchange information with one another, such as through RRCSetupRequest, RRCSetup, and RRCSetupComplete messages.

At 730, the UE 110 detects a trigger event and determines to use a second network access mode as described with reference to FIGS. 7-9. For instance, the adaptive mode selector 220 analyzes the measurement reports and determines the UE 110 has changed locations. As a different example, the user launches another software application at the UE 110 that has more-stringent latency targets and changes the prioritization of the operating performances. Based on determining the UE has changed locations or operational performance prioritizations, the adaptive mode selector 220 analyzes the available network access modes as described with reference to FIGS. 5A-5C and determines to initiate a switch to the second network access mode.

At 1110, based on determining to use the second network access mode at 730, the UE 110 initiates a connection release network procedure. For instance, the adaptive mode selector 220 directs the UE protocol stack 216 to initiate an RRC connection release network procedure at 825 as one of multiple network procedures initiated using the sub-diagram 775. Thus, while shown separately in the diagram 1100, the actions performed at 1110 can be included in the sub-diagram 775.

At 1115, the UE 110, the RAN 140 (by way of the base station 120), and/or the core network 150 perform the connection release procedure. Based on completing the connection release network procedure, the UE 110 communicates in the RAN 140 using the first network access mode and while operating in the idle mode as described at 715 or at 780 of FIG. 7.

At 775, the UE 110 initiates a change in network access modes and transitions to using the second network access mode as described in FIGS. 7-10. As one example, the adaptive mode selector 220 initiates a TAU network procedure as described with reference to FIG. 10. As part of performing the TAU network procedure, the UE protocol stack 216 configures an IE (e.g., UECapabilityInformation IE) based on the second network access mode and indicates support for the second network access mode (without indicating support for the first network access mode) by transmitting the configured IE. The UE 110 then transitions to the second network access mode upon successfully completing the network procedure with the RAN 140 and/or the core network 150. In transitioning to communicating in the RAN using the second network access mode, the UE 110 can exchange signaling and/or control information 755 with the RAN 140 and/or the core network 150, such as by exchanging signaling and/or control information used to perform network procedures (e.g., detach/attach network procedure, a TAU network procedure). Accordingly, the RAN 140 transitions the UE 110 to the second network access mode at 760, and the core network 150 transitions the UE 110 to the second network access mode at 765. This can include the RAN 140 and/or the core network 150 exchanging messaging 770 with one another.

At 780, the UE 110 communicates in the RAN 140 using the second network access mode and while operating in the idle mode. For example, the UE 110 communicates in the RAN 140 with the core network 150 through the base station 120 and using a second protocol and a second set of air interface resources associated with the second network access mode.

In some aspects, the UE 110 intermittently and/or periodically determines to adapt the network access mode from the second network access mode to another network access mode as described at 785 of FIG. 7 (not illustrated). For example, while operating in the idle mode at 780, the UE 110 obtains updated network selection information, evaluates the network access modes based on the updated network selection information, and determines to use a different network access mode to obtain potentially higher performance relative to the second network access mode. Alternatively, or additionally, the UE determines to adapt the network access mode while operating in the connected mode as further described.

### Example Method

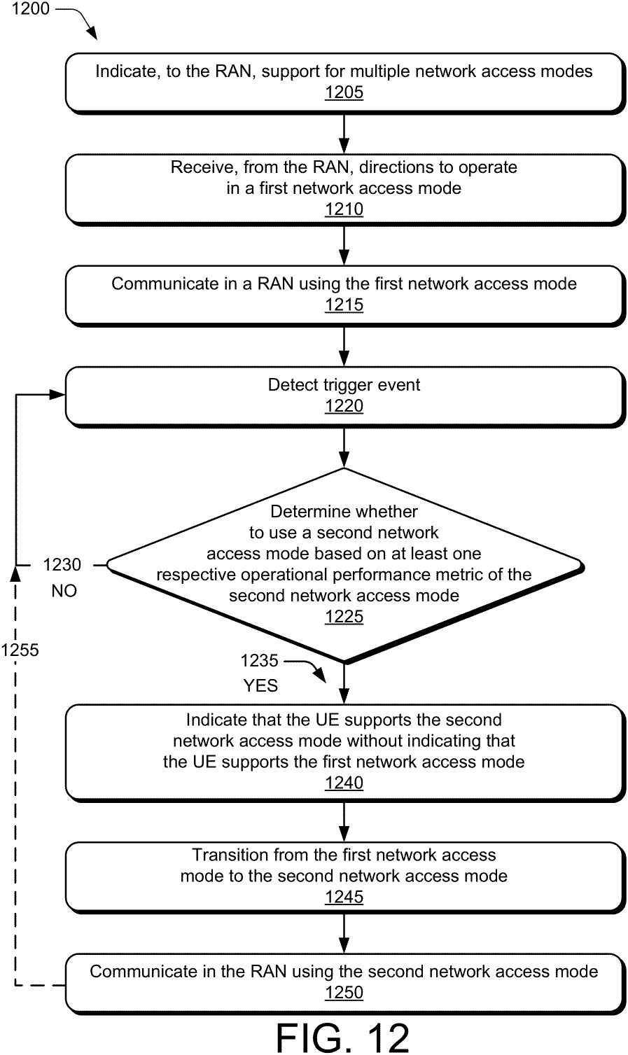

Example method 1200 is described with reference to FIG. 12 in accordance with one or more aspects of adaptive selection of a network access mode by a user equipment. In some aspects, operations of the method 1200 are performed by a user equipment, such as the UE 110 using any aspects described in FIGS. 1-11.

At 1205, a UE indicates, to a RAN, support for multiple network access modes. As one example, the UE 110 indicates support for at least a first network access mode and a second network access mode, such as a SA network access mode and an NSA network access mode. To illustrate, the UE 110 transmits the indication 705 during an access registration procedure as described with reference to FIG. 7.

At 1210, the UE receives, from the RAN, directions to operate in a first network access mode. For example, the UE 110 receives the directions 710 from the RAN 140 as described with reference to FIG. 7, where the directions include an indication to operate in the first network access mode.

Based on receiving the directions to operate in the first network access mode, at 1215, the UE communicates in the RAN using the first network access mode. As one example, the UE 110 communicates with the RAN 140 through one or more base stations 120 using a first protocol and a first set of air interface resources associated with, or specific to, the first network access mode (e.g., a 5G NSA network access mode, a 5G SA network access mode) as described at 715 of FIG. 7 and at 1105 of FIG. 11. In some aspects, the UE 110 operates in an idle mode or an inactive mode, such as an RRC_IDLE mode or an RRC_INACTIVE mode, while in other aspects, the UE operates in a connected mode, such as an RRC_CONNECTED mode.

At 1220, the UE detects a trigger event that indicates to perform a network access mode analysis. For example, the UE 110, by way of the UE protocol stack 216 and the adaptive mode selector 220, obtains the measurement reports 805 of FIG. 8 that indicate available frequencies. Alternatively, or additionally, the UE 110 obtains network information, such as PLMN information (e.g., MCC information, MNC information, TAU information, Cell-ID). In aspects, the UE 110, by way of the adaptive mode selector 220, detects the trigger event by analyzing the measurement reports to identify the available frequencies and determining that the trigger event (e.g., a location change) has occurred when the available frequencies have changed or when the received power levels change by a threshold amount. As another example, the adaptive mode selector 220 determines that the trigger event (e.g., a change in operational performance prioritizations) has occurred.

At 1225, the UE determines whether to use a second network access mode based on at least one respective operational performance metric of the second network access mode. For example, the UE 110, by way of the adaptive mode selector 220, evaluates each network access mode using any combination of a lookup table that indicates a deployment configuration (e.g., lookup table 224), UE-hardware configuration information (e.g., UE hardware configuration 226), a current location, or prioritized operational performance metrics. In some aspects, the UE 110 performs a network access mode analysis that generates analyzes for different network access modes and/or coverage areas as described with reference to FIGS. 5A-5C. The UE 110 then determines a suitable network access mode, such as a current network access mode or the second network access mode as described by the sub-diagram 730 of FIG. 7.

If the UE determines to continue operating in the first network access mode and not initiate a change to the second network access mode, the method proceeds at 1230 and performs another evaluation at a later point in time, such as based on detecting a second trigger event at 1220. If the UE determines to use the second network access mode, the method proceeds at 1235.

At 1240, the UE indicates that the UE supports the second network access mode without indicating that the UE supports the first network access mode. To illustrate, as described by the sub-diagram 775 of FIGS. 7-11, the UE 110, by way of the adaptive mode selector 220, initiates a network procedure. As part of performing the network procedure, the UE 110, by way of the UE protocol stack 216, configures an IE (e.g., UECapabilityInformation IE) based on the second network access mode and indicates support for the second network access mode (without indicating support for the first network access mode) by transmitting the configured IE to the RAN 140. Initiating the network procedure can include initiating multiple network procedures, such as initiating a detach network procedure and then initiating an attach network procedure as described with reference to FIG. 8, initiating a connection release network procedure and then initiating a TAU network procedure as described with reference to FIGS. 10 and 11, or simply initiating a TAU network procedure as described with reference to FIG. 10.

At 1245, the UE transitions from the first network access mode to the second network access mode. For example, the UE 110 successfully completes the network procedure initiated at 1240 and transitions from communicating in the RAN using a first protocol and a first set of air interface resources associated with, or specific to, the first network access mode to a second protocol and a second set of air interface resources associated with, or specific to, the second network access mode.

At 1250, the UE communicates in the RAN using the second network access mode. For instance, as described at 780 of FIG. 7 and FIG. 11, the UE 110 communicates with the base station 120 using a second protocol and a second set of air interface resources associated with, or specific to, the second network access mode (e.g., a 5G SA network access mode, a 5G NSA network access mode) and while operating in an idle mode.

In some aspects, the method 1200 iteratively repeats as indicated at 1255. For instance, the UE 110 periodically and/or intermittently obtains updated measurement reports and/or network information. In response to obtaining the updated reports and/or information, the UE 110 determines whether a different network access mode provides better potential performance as further described. This iterative process allows the UE to dynamically adapt a network access mode to obtain higher potential performance relative to other network access modes as conditions change.

The order in which the method blocks are described is not intended to be construed as a limitation, and any number of the described method blocks can be skipped or combined in any order to implement a method or an alternative method. Generally, any of the components, modules, methods, and operations described herein can be implemented using software, firmware, hardware (e.g., fixed logic circuitry), manual processing, or any combination thereof. Some operations of the example methods may be described in the general context of executable instructions stored on computer-readable storage memory that is local and/or remote to a computer processing system, and implementations can include software applications, programs, functions, and the like. Alternatively, or additionally, any of the functionality described herein can be performed, at least in part, by one or more hardware logic components, such as, and without limitation, Field-programmable Gate Arrays (FPGAs), Application-specific Integrated Circuits (ASICs), Application-specific Standard Products (ASSPs), System-on-a-chip systems (SoCs), Complex Programmable Logic Devices (CPLDs), and the like.

Although aspects of adaptive selection of a network access mode by a user equipment have been described in language specific to features and/or methods, the subject of the appended claims is not necessarily limited to the specific features or methods described. Rather, the specific features and methods are disclosed as example implementations of adaptive selection of a network access mode by a user equipment, and other equivalent features and methods are intended to be within the scope of the appended claims. It is to be appreciated that each described aspect can be implemented independently or in connection with one or more other described aspects.

In the following, several examples are described:

Example 1: A method performed by a user equipment (UE) for determining a network access mode for communicating in a radio access network (RAN) that supports multiple network access modes, the method comprising: indicating, to a network controller of the RAN, support for at least a first network access mode and a second network access mode of the multiple network access modes supported by the RAN; receiving directions to operate in the first network access mode; detecting a trigger event that indicates to perform a network access mode analysis; based on detecting the trigger event, determining to use the second network access mode based on a comparison of at least one operational performance metric of the second network access mode with a respective operational performance metric of the first network access mode; based on the determining to use the second network access mode, indicating, to the network controller, that the UE supports the second network access mode; and transitioning, based on the indicating, from the first network access mode to the second network access mode.

Example 2: The method as recited in example 1, wherein the indicating, to the network controller, that the UE supports the second network access mode further comprises: indicating, to the network controller, that the UE supports the second network access mode without indicating that the UE supports the first network access mode; or indicating, to the network controller, that the UE supports the first network access mode and the second network access mode, and indicating a preference for the second network access mode.

Example 3: The method as recited in example 2, wherein indicating the preference for the second network access mode further comprises: indicating, to the network controller, prioritizations of the first network access mode and the second network access mode, wherein the second network access mode has a higher priority than the first network access mode.

Example 4: The method as recited in example 2 or example 3, wherein indicating that the UE supports the second network access mode further comprises: initiating a network procedure that transmits, to the network controller, a user-equipment-capability-information information element (UECapabilityInformation IE) that indicates one or more capabilities specific to the second network access mode.

Example 5: The method as recited in example 4, further comprising: indicating that the UE supports a non-standalone (NSA) network access mode as the second network access mode without indicating that the UE supports a standalone (SA) network access mode as the first network access mode by: including a user-equipment-multi-radio-access-technology-dual-connectivity-capability information-element (UE-MRDC-Capability IE) in the UECapabilityInformation IE; and omitting a user-equipment-new-radio-capability information-element (UE-NR-Capability IE) from the UECapabilityInformation IE.

Example 6: The method as recited in example 4, further comprising: indicating that the UE supports a standalone (SA) network access mode as the second network access mode without indicating that the UE supports a non-standalone (NSA) network access mode by: including a user-equipment-new-radio-capability information-element (UE-NR-Capability IE) in the UECapabilityInformation IE; and omitting a user-equipment-multi-radio-access-technology-dual-connectivity-capability information-element (UE-MRDC-Capability IE) from the UECapabilityInformation IE.

Example 7: The method as recited in any one of examples 4 to 6, wherein the network procedure comprises: a tracking area update network procedure; or an attach network procedure.

Example 8: The method as recited in example 7, wherein the network procedure comprises the tracking area update network procedure, wherein initiating the network procedure further comprises: initiating a connection release network procedure prior to initiating the tracking area update network procedure, and wherein the method further comprises: based on receiving the directions to operate in the first network access mode, communicating in the RAN using the first network access mode.

Example 9: The method as recited in example 8, wherein the communicating in the RAN using the first network access mode further comprises: operating in an idle mode; or operating in an inactive mode.

Example 10: The method as recited in example 1 or 2, wherein: the first network access mode comprises a fifth generation (5G) non-standalone (NSA) network access mode and the second network access mode comprises a 5G standalone (SA) network access mode; or the first network access mode comprises the 5G SA network access mode and the second network access mode comprises the 5G NSA network access mode.

Example 11: The method as recited in any one of examples 1 to 10, wherein detecting the trigger event comprises: detecting a location change.

Example 12: The method as recited in example 11, wherein detecting the location change comprises: analyzing one or more measurement reports; and detecting that one or more available frequencies have changed; or detecting that one or more received power levels have changed by a threshold amount.

Example 13: The method as recited in any one of examples 1 to 12, wherein the determining to use the second network access mode further comprises: determining that the second network access mode provides a higher data throughput relative to the first network access mode; and determining to initiate a change to the second network access mode based on the higher data throughput.

Example 14: The method as recited in any one of examples 1 to 12, wherein the determining to use the second network access mode further comprises: determining that the first network access mode and the second network access mode provide commensurate performance for a first performance metric; determining that the second network access mode provides a higher performance for a second performance metric relative to the first network access mode; and determining to initiate a change to the second network access mode based on the second performance metric.

Example 15: The method as recited in example 14, wherein the first performance metric comprises one of: a data throughput metric or a data-transfer latency metric, and wherein the second performance metric comprises: the other of the data throughput metric and the data-transfer latency metric.

Example 16: The method as recited in any one of examples 1 to 15, further comprising: based on receiving the directions to operate in the first network access mode, communicating in the RAN using the first network access mode.

Example 17: The method as recited in any one of examples 1 to 16, further comprising: based on transitioning to the second network access mode, communicating in the RAN using the second network access mode.

Example 18: A user equipment comprising: a wireless transceiver; a processor; and computer-readable storage media comprising instructions that, responsive to execution by the processor, direct the user equipment to perform a method as recited in any one of examples 1 to 17.

Example 19: A computer-readable storage media comprising instructions that, responsive to execution by a processor, cause a method as recited in any one of examples 1 to 17 to be performed.

1. A method performed by a user equipment (UE) for determining a network access mode for communicating in a radio access network (RAN), the UE being able to operate using a first network access mode and a second network access mode, the method comprising:
while operating using the first network access mode, detecting a trigger event that indicates to perform a network access mode analysis;
upon detecting the trigger event, determining to use the second network access mode based on the network access mode analysis that includes a comparison of at least one operational performance metric of the second network access mode with a respective operational performance metric of the first network access mode; and
indicating, to the RAN, that the UE supports the second network access mode; to cause a transition, from the first network access mode to the second network access mode.

2. The method as recited in claim 1, wherein the indicating that the UE supports the second network access mode comprises:
indicating that the UE supports the second network access mode without indicating that the UE supports the first network access mode; or
indicating that the UE supports the first network access mode and the second network access mode, and indicating a preference for the second network access mode.

3. The method as recited in claim 2, wherein the indicating of the preference for the second network access mode further comprises:
indicating a priority of the first network access mode and a priority of the second network access mode, wherein the second network access mode has a higher priority than the first network access mode.

4. The method as recited in claim 2, wherein the indicating that the UE supports the second network access mode further comprises:
initiating a network procedure for transmitting to the RAN a user-equipment-capability-information information element (UECapabilityInformation IE) that indicates one or more capabilities specific to the second network access mode.

5. The method as recited in claim 4, wherein the one or more capabilities specific to the second network access mode include:
indicating an indication that the UE supports a non-standalone (NSA) network access mode as the second network access mode while not indicating that the UE supports a standalone (SA) network access mode as the first network access mode by:
including a user-equipment-multi-radio-access-technology-dual-connectivity-capability information-element (UE-MRDC-Capability IE) in the UECapabilityInformation IE; and
omitting a user-equipment-new-radio-capability information-element (UE-NR-Capability IE) from the UECapabilityInformation IE.

6. The method as recited in claim 4, wherein the one or more capabilities specific to the second network access mode include:
indicating an indication that the UE supports a standalone (SA) network access mode as the second network access mode while not indicating that the UE supports a non-standalone (NSA) network access mode by:
including a user-equipment-new-radio-capability information-element (UE-NR-Capability IE) in the UECapabilityInformation IE; and
omitting a user-equipment-multi-radio-access-technology-dual-connectivity-capability information-element (UE-MRDC-Capability IE) from the UECapabilityInformation IE.

7. The method as recited in claim 4, wherein the network procedure comprises:
a tracking area update network procedure; or
an attach network procedure.

8. The method as recited in claim 7, wherein the network procedure comprises the tracking area update network procedure, and the initiating of the network procedure further comprises:
initiating a connection release network procedure prior to initiating the tracking area update network procedure, and
wherein the method further comprises:
receiving, from the RAN, directions to operate in the second network access mode; and
communicating in the RAN using the second network access mode.

9. The method as recited in claim 8, wherein the operating in the RAN using the first network access mode comprises:
operating in an idle mode; or
operating in an inactive mode.

10. The method as recited in claim 1, wherein:
the first network access mode comprises a fifth generation (5G) non-standalone (NSA) network access mode and the second network access mode comprises a 5G standalone (SA) network access mode; or
the first network access mode comprises the 5G SA network access mode and the second network access mode comprises the 5G NSA network access mode.

11. The method as recited in claim 1, wherein detecting the trigger event comprises:
detecting a location change.

12. The method as recited in claim 1, wherein the comparison indicates that the second network access mode is able to provide a higher data throughput relative to the first network access mode; and
the determining to use the second network access mode is based on the indication of the higher data throughput.

13. The method as recited in claim 1, wherein the comparison indicates that the first network access mode and the second network access mode provide commensurate performance for a first performance metric;
that the second network access mode provides a higher performance for a second performance metric relative to the first network access mode; and
the determining to use the second network access mode is based on the indication of the second performance metric.

14. The method as recited in claim 13, wherein the first performance metric comprises one of:
a data throughput metric or a data-transfer latency metric, and
wherein the second performance metric comprises:
the other of the data throughput metric and the data-transfer latency metric.

15. A user equipment (UE) comprising:
a wireless transceiver;
a processor; and
computer-readable storage media comprising instructions that, responsive to execution by the processor, direct the user equipment to:
while operating using a first network access mode, detect a trigger event that indicates to perform a network access mode analysis;
upon detection of the trigger event, determine to use a second network access mode based on the network access mode analysis that includes a comparison of at least one operational performance metric of the second network access mode with a respective operational performance metric of the first network access mode; and
indicate, to a Radio Access Network (RAN), that the UE supports the second network access mode to cause a transition from the first network access mode to the second network access mode.

16. The user equipment of claim 15, wherein the indication that the UE supports the second network access mode directs the UE to:
indicate that the UE supports the second network access mode without indicating that the UE supports the first network access mode; or
indicate that the UE supports the first network access mode and the second network access mode, and a preference for the second network access mode.

17. The user equipment of claim 16, wherein the indication of the preference for the second network access mode directs the UE to:
indicate a priority of the first network access mode and a priority of the second network access mode, wherein the second network access mode has a higher priority than the first network access mode.

18. The user equipment of claim 16, wherein the indication that the UE supports the second network access mode directs the UE to:
initiate a network procedure for transmitting RAN, a user-equipment-capability-information information element (UECapabilityInformation IE) that indicates one or more capabilities specific to the second network access mode.

19. The user equipment of claim 18, wherein the one or more capabilities specific to the second network access mode include:
an indication that the UE supports a non-standalone (NSA) network access mode as the second network access mode while not indicating that the UE supports a standalone (SA) network access mode as the first network access mode by:
including a user-equipment-multi-radio-access-technology-dual-connectivity-capability information-element (UE-MRDC-Capability IE) in the UECapabilityInformation IE; and
omitting a user-equipment-new-radio-capability information-element (UE-NR-Capability IE) from the UECapabilityInformation IE.

20. The user equipment of claim 18, wherein the one or more capabilities specific to the second network access mode include:
an indication that the UE supports a standalone (SA) network access mode as the second network access mode while not indicating that the UE supports a non-standalone (NSA) network access mode by:
including a user-equipment-new-radio-capability information-element (UE-NR-Capability IE) in the UECapabilityInformation IE; and
omitting a user-equipment-multi-radio-access-technology-dual-connectivity-capability information-element (UE-MRDC-Capability IE) from the UECapabilityInformation IE.
